(19) United States
(12) Patent Application Publication
(10) Pub. No.: US 2003/0125983 A1
(43) Pub. Date: Jul. 3, 2003

(54) Computer-implemented method and system for managing patient healthcare and evaluating patient kidney function

(76) Inventors: John M. Flack, Orchard Lake, MI (US); Lowell A. Hedquist, Walled Lake, MI (US)

Correspondence Address: BROOKS & KUSHMAN, 1000 TOWN CENTER 22ND FL, SOUTHFIELD, MI, 48075

(21) Appl. No.: 10/036,202

(22) Filed: Dec. 27, 2001

(51) Int. Cl. G06F 17/60

(52) U.S. Cl. 705/2

(57) ABSTRACT

A computer-implemented method and system for managing patient healthcare and evaluating patient kidney function. A user creates a medical record for a patient, comprising a catalog of the patient's healthcare encounters. For each encounter, a plurality of modules are provided for defining various aspects of the patient's visit including patient demographics, medical history, current medical condition, diagnosis and treatment. Based on the patient's medical record and estimated glomerular filtration rate, a plurality of patient treatment recommendations are automatically generated. Another aspect of the invention generates clinical treatment goals for the patient. The invention is additionally configured to generate a plurality of reports including patient medical records, physician referral letters and clinical reports comprising an aggregation of various user-defined metrics extracted globally or semi-globally from among a plurality of patient records.

### BACKGROUND OF THE INVENTION

1. Field of the Invention

The present invention relates generally to patient healthcare management methods and systems, and more particularly to patient healthcare management methods and systems having capability to evaluate patient kidney function.

2. Background Art

With rising healthcare costs and increases in the overall volume of clinical visits, efficient patient management, diagnosis and treatment is imperative. Efficient patient management demands maintenance of accurate and up-to-date patient records. Efficient diagnosis and treatment requires that nurses and physicians make appropriate medical decisions quickly based on the proper patient criteria. Commonly, however, healthcare staff are over-extended or exhausted when carrying out their daily patient care routines. As a result, mistakes in record keeping or treatment are increasingly common. Notably, these mistakes involve a broad variety of circumstances ranging from trivial errors in a patient's medical record to negligence in prescribing antagonizing medications leading to medical malpractice or even patient death.

Several software applications have been developed to assist healthcare providers in managing patient records, diagnoses and treatment. Some prior art systems receive user input defining a patient's medical condition and, based on that condition, automatically generate a diagnosis and/or recommended treatment. For example, one software application provides a graphical interface allowing a user to select from a variety of common patient symptoms. Depending on the symptoms selected, the software presents a selectable listing of potential diagnoses associated with the selected symptoms. The software then receives user input selecting a tentative diagnosis from among the potential diagnoses listed. In response, the software automatically generates a recommended therapy for the tentative diagnosis.

Another software application utilizes diagnosis-based guidelines structured to operate in a question and answer methodology to guide a user through a medical evaluation process. Depending on the answers provided, the system provides a user with guideline treatment option(s). At the foundation of the system is a set of diagnosis-based guidelines that are derived from medical professional and healthcare management expertise. Each guideline is associated with a particular healthcare condition for which treatment exists. Each guideline is intended to lead a system user through a sequence of interactive data-collection queries based on the specified healthcare condition observed in an individual patient. The data collection queries are logically structured so that the guideline user identifies pertinent patient characteristics and is led to an endpoint that is usually one guideline treatment option. However, the endpoint may also be two or more alternative treatments.

One function conventional software applications for patient management and treatment lack is the ability to actively monitor a patient's medical record and, based on the patient's medical record, automatically warn the patient's healthcare provider of contraindicated treatment therapies. Consider for example blood pressure treatments. When prescribing treatments for high blood pressure, physicians often rely on their patient's serum creatinine levels to indicate kidney function. Serum creatinine levels, however, are a less accurate indicator of kidney function than the patient's estimated glomerular filtration rate (EGFR). Nonetheless, doctors conventionally rely on serum creatinine levels when prescribing medications because EGFRs are somewhat complicated to calculate. Consequently, doctors generally rely on each patient's serum creatinine level determined from the patient's medical laboratory results. In many cases, however, a patient's serum creatinine level provides an false indication of renal function and leads a doctor to improperly prescribe a contraindicated treatment therapy or less than an optimal treatment that is not necessarily contraindicated. Consider the following case:

Patient is a 71 year old woman with hypertension of long duration and a serum creatinine level of 1.2 mg/dl. According to standard medical guidelines, a serum creatine level of 1.2 mg/dl for this patient suggests a normal renal function. Because this patient was thought to have normal renal function, her physician prescribed a thiazide-like diuretic, chlorthalidone, along with trandolapril, an ACE inhibitor.

Despite having a normal creatinine level, however, the patient's EFGR was 45.5 ml/min/1.73 m². Normal EGFR for this patient is greater than 90 ml/min/1.73 m² and kidney function is considered to be moderately reduced when the EGFR is less than 60 ml/min/1.73 m². Given the magnitude of her reduced kidney function, the patient did not have enough residual renal function for the prescribed chlorthalidone to work effectively. In other words, the patient had been prescribed the wrong diuretic due to her physician's reliance on the patient's serum creatinine level instead of her EFGR. In addition, her goal blood pressure was incorrectly assumed to be <140/90 mmHg instead of <130/85 mmHg. The lower goal blood pressure is recommended for a person with reduced kidney function and, if achieved, will more adequately slow her loss of kidney function than a blood pressure level of closer to 140/90 mmHg.

To resolve the improper treatment, the patient's prescription of chlorthalidone was discontinued and replaced by zaroxylyn, a diuretic that works effectively in persons with reduced kidney function. As a result, the patient's blood pressure was reduced from 154/90 mmHg when taking the chlorthalidone to 120/70 when taking the zaroxylyn, substantially below the patient's minimum target blood pressure of 130/85 mmHg.

Accordingly, a method and system for automatically warning healthcare providers of contraindicated treatment therapies is needed.

Another function many conventional software applications for patient management and treatment lack is the ability to actively monitor a patient's medical record and, based on the patient's medical record, automatically alert the patient's healthcare provider of helpful information and treatment recommendations. For example, prior art systems do not automatically calculate target treatment values (i.e., blood pressure, lipid and cholesterol levels, etc.) for patients that are uniquely tailored to each patient's unique medical record. Accordingly, prior art systems fail to provide an indication as to whether or not patients have met their target treatment values. Prior art systems also lack functionality to automatically alert a treating physician, when appropriate, that concurrent medications may be antagonizing or whether changing medications is prudent considering relevant aspects of the patient's medical record. Another feature prior art systems lack is functionality to actively provide preventative health screening guidelines for asymptomatic patients based on the status of their individual medical records.

Yet another function conventional patient management and treatment systems lack is the ability to generate aggregate clinical reports which are automatically populated with relevant criteria extracted globally from patient medical records. Aggregate clinical reports generated in accord with the present invention provide information about overall healthcare practice that can be used to assess, for example, the quality of healthcare treatment, healthcare processes undertaken and the clinical outcomes of patient treatment. Aggregate clinical reports can also be utilized by healthcare providers to document compliance with clinical care practice standards as defined by medical organizations such as the American Diabetes Association, the National Kidney Foundation, the Joint National Commission on the Detection, Evaluation and Treatment of Hypertension (JNC-VI), HEDIS, the National Cholesterol Education Program, as well as other organizations. From a healthcare business perspective, aggregate clinical reports provide an excellent marketing tool for attracting major healthcare insurance providers as well as the lay public who may be seeking a preferred healthcare provider.

What is needed is an innovative solution to these and other deficiencies associated with prior art patient management and treatment systems.

### SUMMARY OF THE INVENTION

It would be advantageous to have a computer-implemented method and system for managing patient records, diagnoses and treatments in a healthcare practice. The solution should provide user interfaces allowing a broad range of healthcare providers to easily create, modify, search, append to and generally navigate among patient records. Preferably, a plurality of patient encounter modules are provided for easily reporting and tracking patient complaints, conditions, diagnoses and treatment associated with each patient visit to a healthcare provider. The patient encounter modules should accommodate a variety of common patient encounters including doctor visits, nurser visits, emergency room visits and telephone encounters. In addition, the solution should facilitate the generation and export of a variety of reports including individual patient encounter summaries, medical records as well as a variety of aggregate clinical reports.

A system embodiment of the present invention includes a computer system configured to receive input defining a patient's medical record (e.g. patient demographic information, medical condition, diagnosis, etc.), calculate the patient's estimated glomerular filtration rate based on the patient's medical record, output at least one medical treatment recommendation based on the patient's medical record and estimated glomerular filtration rate, and calculate at least one treatment goal for the patient. A system embodiment may additionally be configured to receive input specifying a treatment for the patient. The patient treatment goal may include goals such as a goal blood pressure, a goal lipid level, a goal cholesterol level, and a goal hemoglobin A1C level. A system embodiment may additionally be configured to output an indication as to whether, based on the patient's medical, the at least one medical treatment goal has been met. A plurality of clinical treatment algorithms may be applied to the patient's medical record to generate a treatment recommendation and/or treatment goal. A system embodiment may be additionally configured to receive input specifying a patient's current medication, receiving input specifying a new prescription for the patient, and generate an alert if the prescribed medication may antagonize a medication that the patient is currently taking. A system embodiment may be further configured to receive input defining a plurality of patient medical records including patient demographics, medical condition, diagnosis and treatment, receive input defining one or more medical record parameters to extract from the plurality of medical records, and automatically generate a report containing an aggregate of the one or more medical record parameters extracted from the plurality of medical records. A system embodiment may additionally be configured to receive input to define a subset of a plurality of patient medical records from which one or more medical record parameters are extracted. A system embodiment may be additionally configured to receive input, for each patient encountered with his or her healthcare provider, defining the patient encounter wherein each defined patient encounter is appended to the patient's medical record.

A method embodiment of the present invention includes a computer-implemented method for interactively managing patient healthcare. The method embodiment includes defining a patient's medical record including the patient's demographic information, medical condition and diagnosis, calculating the patient's estimated glomerular filtration rate based on the patient's medical record, automatically generating at least one medical treatment recommendation based on the patient's medical record and estimated glomerular filtration rate, and calculating at least one treatment goal for the patient. A method embodiment may additionally include specifying a treatment for the patient. The at least one patient treatment goal may include a goal blood pressure level, a goal lipid level, a goal cholesterol level, and a goal hemoglobin A1C level. A method embodiment may additionally include indicating whether, based on the patient's medical record, the at least one patient treatment goal has been met. A method embodiment may additionally include applying a plurality of clinical treatment algorithms to the patient's medical record to generate the at least one treatment recommendation and the at least one patient treatment goal. A method embodiment may additionally include specifying the patient's current medications, specifying a new prescription for the patient, and generating an alert if the prescribed medication may antagonize a medication the patient is currently taking. A method embodiment may additionally include defining a plurality of patient medical records including demographic information, medical condition, diagnosis and treatment, defining at least one medical record parameter to extract from the plurality of medical records, and automatically generating a report containing an aggregate of the at least one medical record parameter extracted from the plurality of medical records. A method embodiment may additionally include defining a subset of the plurality of patient medical records from which to extract the at least one medical record parameter. A method embodiment may additionally include defining each patient encounter with his or her healthcare provider wherein the defined patient encounter is appended to the patient's medical record.

The above objects, advantages and embodiments of the present invention, as well as other objects, features, advantages and embodiments of the present invention are readily apparent from the following detailed description of the preferred embodiments, when taken in conjunction with the drawings thereof. Notably, neither the written description of the preferred embodiments of the present invention or corresponding drawings thereof are intended to limit the scope of the present invention. Those of ordinary skill in the relevant art will recognize that various modifications and adaptations may be made to the preferred embodiments within the spirit and scope of the present invention.

### BRIEF DESCRIPTION OF THE DRAWINGS

FIG. 1 illustrates a preferred computer system for implementing the present invention;

FIG. 2 illustrates, in block flow format, an overview of a preferred process for implementing the present invention;

FIG. 3 is an example GUI for adding (or updating) general patient information to the patient's medical record;

FIG. 4 is an example GUI for maintaining and managing a patient's medical record;

FIG. 5 illustrates an example GUI for the Patient Medical History Patient Encounter Module;

FIG. 6 illustrates an example GUI for the Visit Vitals/complaint Patient Encounter Module;

FIG. 7 is an example GUI illustrating the visit vitals aspect of the Visit Vitals/complaint Patient Encounter Module;

FIG. 8 is an example GUI generated when a user requests a blood pressure summary;

FIG. 9 is an example GUI generated when a user requests a blood pressure trend graph;

FIG. 10 illustrates an example GUI for the Review of Systems Patient Encounter Module;

FIG. 11 illustrates an example GUI for the Medications Patient Encounter Module;

FIG. 12 illustrates an example GUI for the Physical Exam Patient Encounter Module;

FIG. 13 illustrates an example GUI for the Visit Lab Orders Patient Encounter Module;

FIG. 14 illustrates an example GUI for inputting lab results;

FIG. 15 illustrates an example GUI for the Index of Lab Orders Patient Encounter Module;

FIG. 16 illustrates an example GUI for the Secondary Hypertension Patient Encounter Module;

FIG. 17 illustrates an example GUI containing an estimated glomerular filtration rate calculator;

FIG. 18 illustrates an example GUI containing an LDL cholesterol goal calculator;

FIG. 19 illustrates an example GUI for the Impression/Treatment Plan Patient Encounter Module;

FIG. 20 illustrates an example GUI containing a form for defining a medical treatment plan for a patient;

FIG. 21 illustrates an example GUI for the Calculated Statements Patient's Encounter Module;

FIG. 22 illustrates an example portion of a graphical treatment algorithm pertaining particularly to hypertension treatment for persons with type 2 Diabetes Mellitus;

FIG. 23 illustrates an example pop-up window that may be automatically generated based on the status of a patient's medical record and/or user activity;

FIG. 24 illustrates an example GUI for the Thank You for Referral Letter Patient Encounter Module;

FIG. 25 illustrates an example GUI for the Refer to Physician Letter Patient Encounter Module;

FIG. 26 illustrates an example GUI for the Print Visit Patient Encounter Module;

FIG. 27 illustrates an example GUI for browsing/updating and adding physicians to the physician database; and

FIG. 28 illustrates an example GUI for generating an aggregate clinical report.

### DETAILED DESCRIPTION OF THE PREFERRED EMBODIMENT(S)

### System Architecture

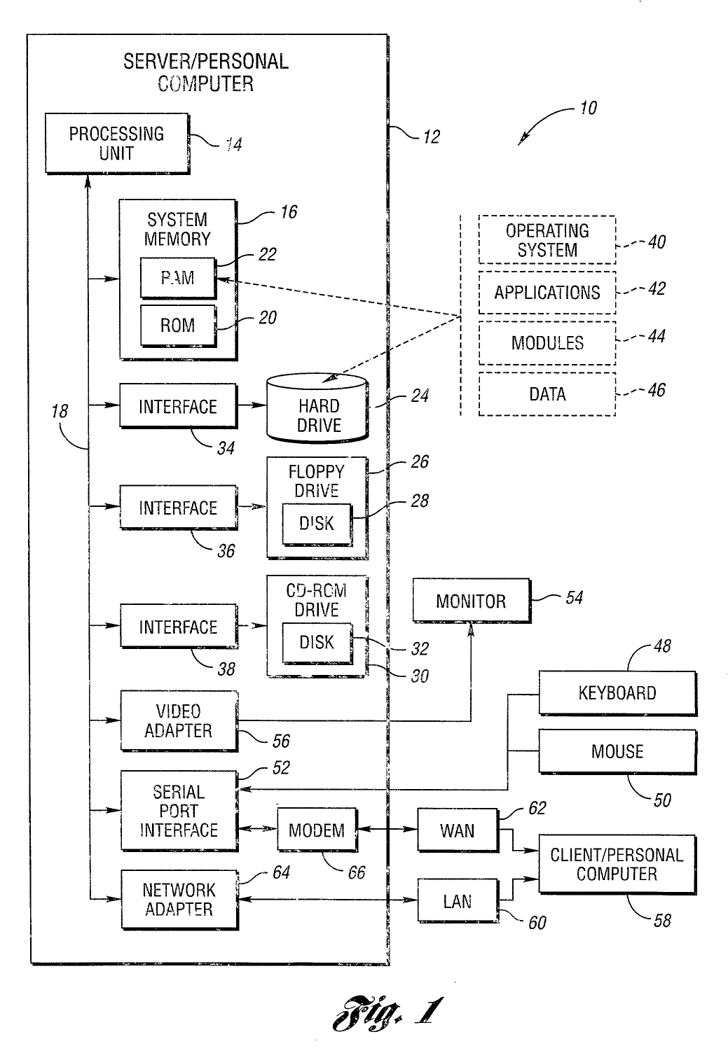

FIG. 1 and its associated description are intended to provide a brief, general description of suitable computing environments for implementing the present invention. According to one embodiment, the system comprises a stand-alone personal computing environment. According to another embodiment, the system comprises a networked computer environment having a typical server-client configuration. Notably, a plurality of computing environments are understood by those skilled in the art of computing architecture and may be configured for implementing the present invention.

FIG. 1 illustrates a preferred computer system 10 for implementing the present invention. The computer system 10 comprises a server or personal computer 12 including a processing unit 14, a system memory 16 and a system bus 18 that interconnects various system components including the system memory 16 to the processing unit 14. The system bus 18 may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 20 and random access memory (RAM) 22. A basic input/output system (BIOS), containing the basic routines that help to transfer information between elements within the computer 12, such as during start-up, is stored in ROM 20. The computer 12 further includes a hard disk drive 24, a magnetic disk drive (floppy drive, 26) to read from or write to a removable disk 28, and an optical disk drive (CD-ROM Drive, 30) for reading a CD-ROM disk 32 or to read from or write to other optical media. The hard disk drive 24, magnetic disk drive 26, and optical disk drive 30 are connected to the system bus 18 by a hard disk drive interface 34, a magnetic disk drive interface 36 and an optical drive interface 38, respectively. The drives and their associated computer-readable media provide nonvolatile storage of data, data structures, computer-executable instructions (program code such as dynamic link libraries, and executable files), etc. for the computer 12. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 22, including an operating system 40, one or more application programs 42, other program modules 44, and program data 46. A user may enter commands and information into the computer 12 through a keyboard 48 and pointing device, such as a mouse 50. Other input devices (not shown) may include a microphone, dictaphone, scanner, or the like. These and other input devices are often connected to the processing unit 14 through a serial port interface 52 that is coupled to the system bus, but may be connected by other interfaces, such as a parallel port, game port or a universal serial bus (USB). A monitor 54 or other type of display device is also connected to the system bus 18 via an interface, such as a video adapter 56. In addition to the monitor, the computer may include other peripheral output devices (not shown), such as speakers and a printer.

In a networked configuration, there are several client computers 58 having a similar architecture to computer 12 and configured to operate as a client to computer 12 configured to operate as a server. The logical connections depicted in FIG. 1 between server computer 12 and any client computer 58 include (but are not limited to) a local area network (LAN) 60 and a wide area network (WAN) 62. Such networking environments are commonplace in offices, enterprise-wide computer networks, intranets and the Internet.

When used in a LAN networking environment, the server computer 12 is connected to the local network 60 through a network interface or adapter 64. When used in a WAN networking environment, the server computer 12 typically includes a modem 66 or other means for establishing communications over the wide area network 62, such as the Internet. The modem 66, which may be internal or external, is connected to the system bus 18 via the serial port interface 52. In a networked environment, program modules depicted relative to the server computer 12, or portions of them, may be stored in a remote memory storage device (not shown).

### Application Software

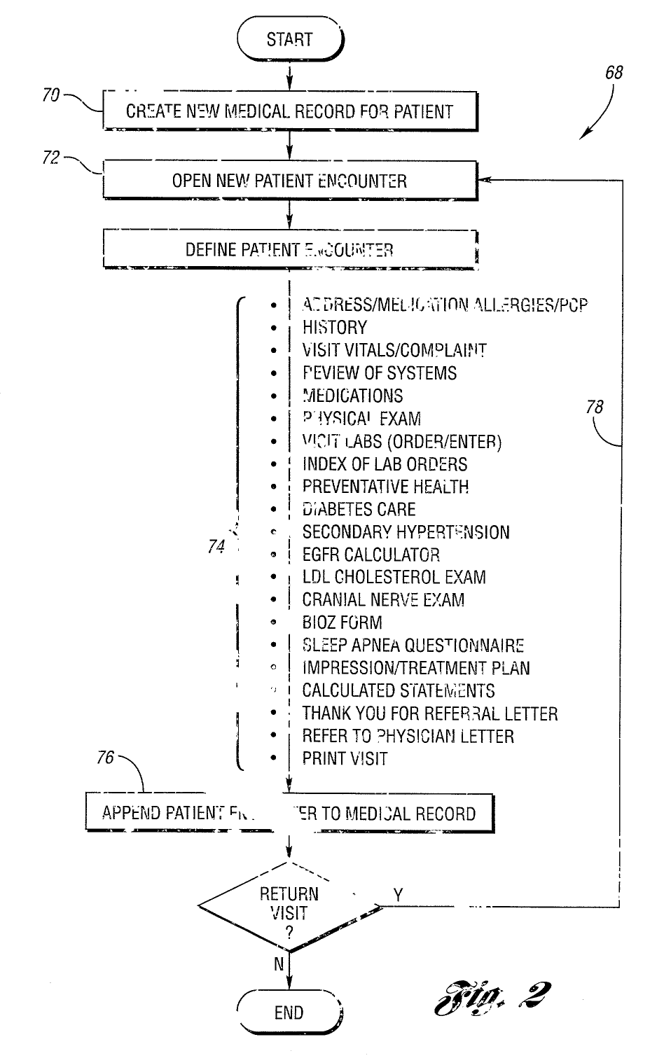

FIG. 2 illustrates, in a block flow format, an overview of a preferred process 68 for implementing the present invention in a software format. For clarity, the general flow illustrated in FIG. 2 tracks a conventional patient encounter with his or her healthcare provider. Notably however, the navigation sequence 68 may be rearranged in a plurality of configurations within the scope of the present invention.

The preferred software process 68 begins with a user creating (i.e., opening) a new medical record for a patient as represented by block 70. As discussed in more detail infra, opening a new medical record for a patient includes inputting his or her demographic information, medication allergies, clinic physician information and referring/primary physician information where applicable. Next, the user creates (opens) a “Patient Encounter” for the patient's current visit as represented by block 72. As also discussed in more detail infra, the patient encounter aspect of the software comprises a plurality of interactive graphical user interfaces (GUIs) 74 for defining the patient's current encounter with his or her healthcare provider. As represented by block 76, each patient encounter is separately appended to and becomes part of the patient's medical record.

As indicated by arrow 78, a separate patient encounter is created and defined for each subsequent patient visit or contact with his or her healthcare provider. Notably, aspects of the patient's existing medical record such as patient demographics, allergies, medical history, etc. need only be updated where necessary in subsequent patient encounters.

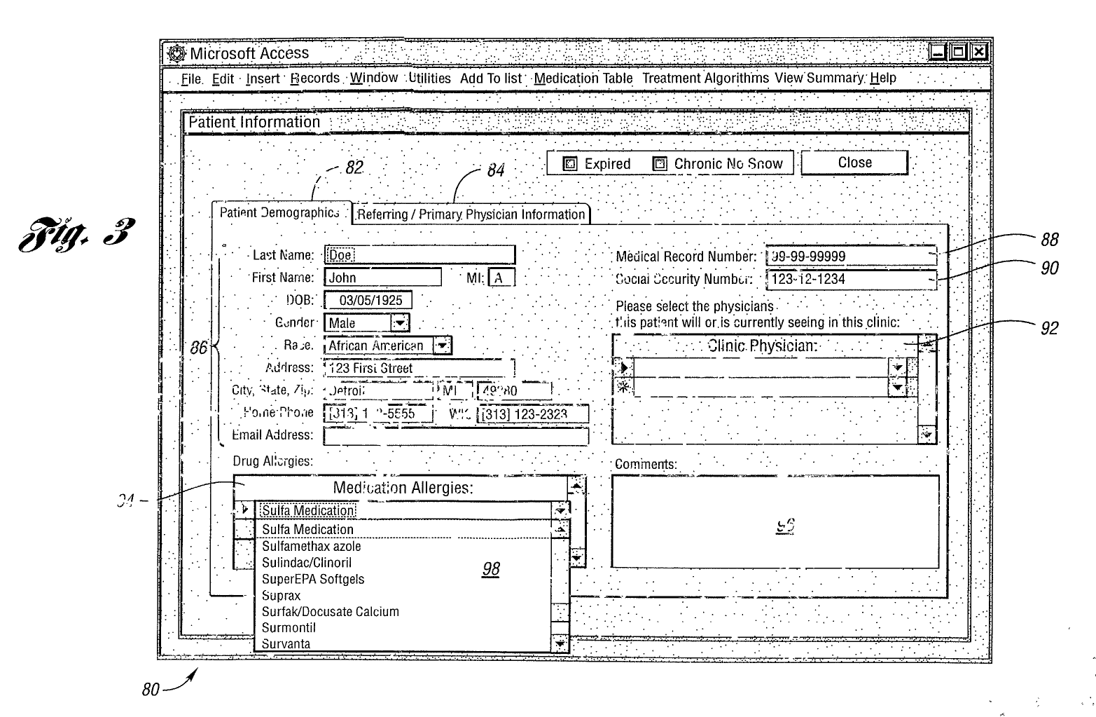

FIG. 3 is an example GUI 80 for adding (or updating) general patient information to the patient's medical record. “Patient Information” form 80 comprises a “Patient Demographics” form 82 and a “Referring/Primary Physician Information” for 84.

The “Patient Demographics” form 82 comprises a plurality of patient contact information 86, a medical record number 88, the patient's social security number 90, a clinical physician selection form 92, a medication allergies selection form 94, and a comment entry field 96.

Each field of the “Medication Allergies” selection form 94 has an associated drop-down menu 98 for facilitating data input. As discussed in more detail infra, the content of drop-down menu 98 is dictated by a user-defined database of commonly-selected or preferred medications. Notably, medications that are not included within the drop-down menu 98 may be added manually.

Similarly, each field of the “Clinical Physician” selection form 92 has an associated drop-down menu (not shown) containing a plurality of previously-entered physicians or user-defined physicians included within a database of commonly-selected or preferred physicians. Physicians that are not included within the drop-down menu can be added manually to the “Clinical Physician” selection form 92.

GUIs provided in accord with the present invention, such as the GUI illustrated in FIG. 3, may be configured to receive input in a variety of different manners. Methods for data input envisioned are well known in the fields of information and communication technoloy. Preferred methods of data input include but are not limited to keyboard input, mouse input, scanner/word pad input including character recognition applications and voice input including voice recognition applications.

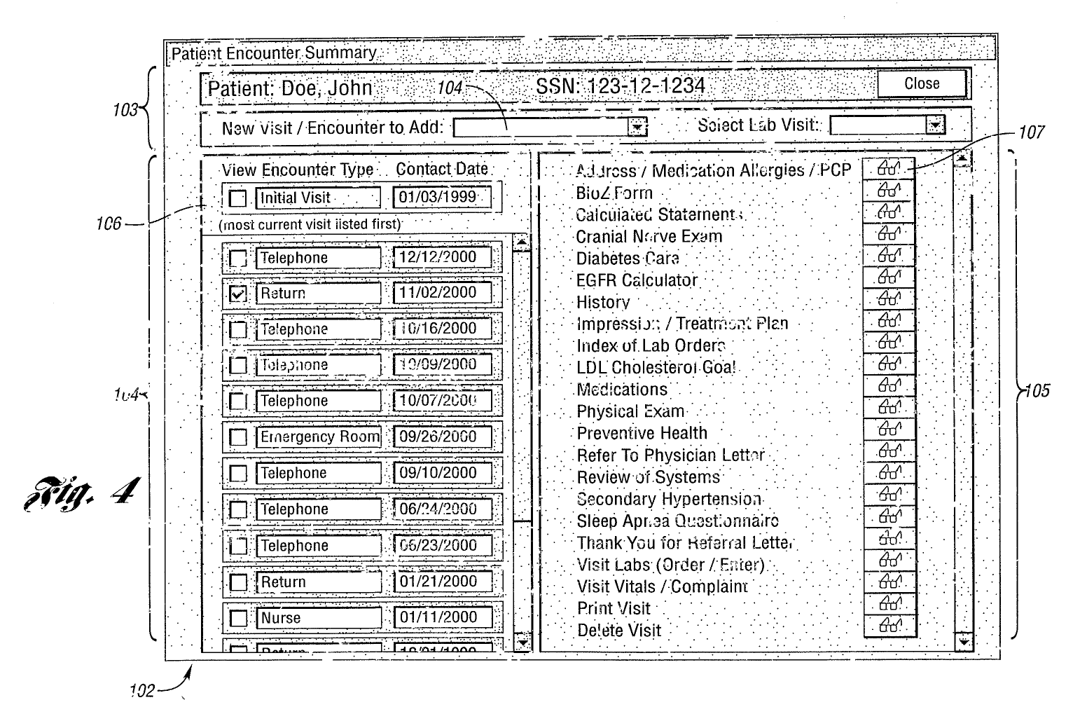

FIG. 4 is an example GUI 102 for maintaining and managing a patient's medical record. Via GUI 102 a user can update a patient's existing medical record (i.e., demographic information, medical history, etc.), browse previous patient encounters, create a new patient encounter and perform a variety of related patient management functions.

GUI 102 generally comprises a header 103, a patient encounter catalog 104 and a patient encounter summary 105. Header 103 comprises the patient's name, social security number and a “New Encounter” field 104 for specifying a new patient encounter to be created and appended to the patient's medical record. Patient encounter types 104 include but are not limited to: an initial patient encounter, return encounter, nurse encounter, telephone encounter and emergency room encounter.

Patient encounter catalog 104 contains a graphical catalog of patient encounters previously-appended to the patient's medical record. The first patient encounter listed is the patient's initial encounter 106. Subsequent encounters are listed in chronological order beginning with the most recent visit.

Patient encounter summary 105 comprises a plurality of modules 107 for defining a new patient encounter or browsing a previously-appended patient encounter selected in patient encounter catalog 104. Each of the modules 107 included within the patient encounter summary 105 are discussed in greater detail infra.

Notably, the patient encounter modules 107 are not limited to those presented in patient encounter summary 105. In addition, the combination of patient encounter modules 107 included within a patient encounter summary 105 may vary depending on the type of patient encounter created or selected (i.e., initial patient encounter, return encounter, nurse encounter, telephone encounter, emergency room encounter, etc.). For example, a telephone encounter summary (not shown) will not include the modules pertaining to a patient's medical examination. Instead, the encounter summary will contain a module for summarizing the telephone conversation (e.g., person taking call, telephone complaint, actions taken, etc.). Similarly, an emergency room encounter summary (not shown) includes a module for summarizing the patient's emergency room visit (e.g., ER physician, chief complaint, actions taken, etc.).

### Example Patient Encounter Modules

The “Address/Medication Allergies/PCP” encounter module comprises the “Patient Demographics” form 82 previously illustrated and described in FIG. 3.

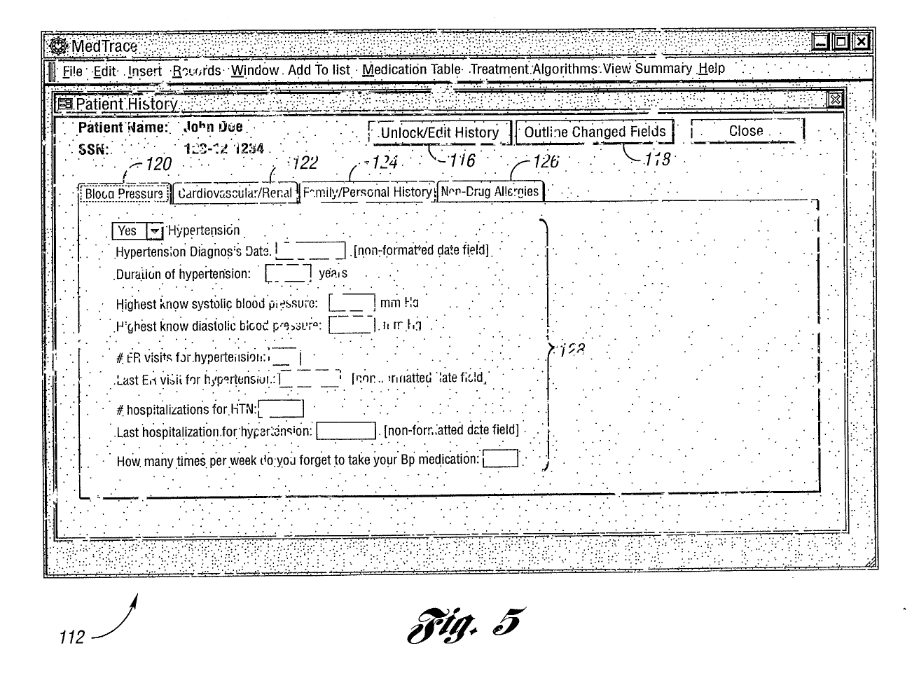

FIG. 5 illustrates an example GUI 112 for the “Patient Medical History” patient encounter module. Patient medical history form 112 comprises an indication of the patient's name and social security number, a button 116 labeled “Unlock/Edit History” for accessing and editing previously-entered information, a button 118 labeled “Outline Changed Fields” to identify changes previously made in the patient's medical history, and a plurality of history forms 120-126 pertaining to different aspects of the patients medical history, each form having its respective navigation tab.

Medical history forms 120-126 comprise a plurality of data input and selection fields 128 pertaining to a variety of patient medical history categories 120-126. Categories include but are not limited to: “Blood Pressure” 120, Cardiovascular/Renal” 122, “Family/Personal History” 124 and “Non-Drug Allergies” 126.

Preferably, a patient's medical history information that has been input into the plurality of patient history forms 120-126 is automatically locked for editing within 24 hours after the time the data was input to insure data integrity. To “Unlock” and edit previously-entered information, the user selects the “Unlock/Edit History” button 116. Prior to unlocking the form for editing patient data, the software automatically archives the current unedited data, the current date, and the user identification corresponding to the user currently logged into the software.

As discussed in more detail infra, the patient medical history information input into forms 120-126 is subsequently utilized in calculations to determine appropriate treatment recommendations and warnings. Accordingly, it is important that the user take care to accurately input the patient's medical history information and update the medical history information as necessary to reflect any significant changes in the patient's medical condition during the course of treatment.

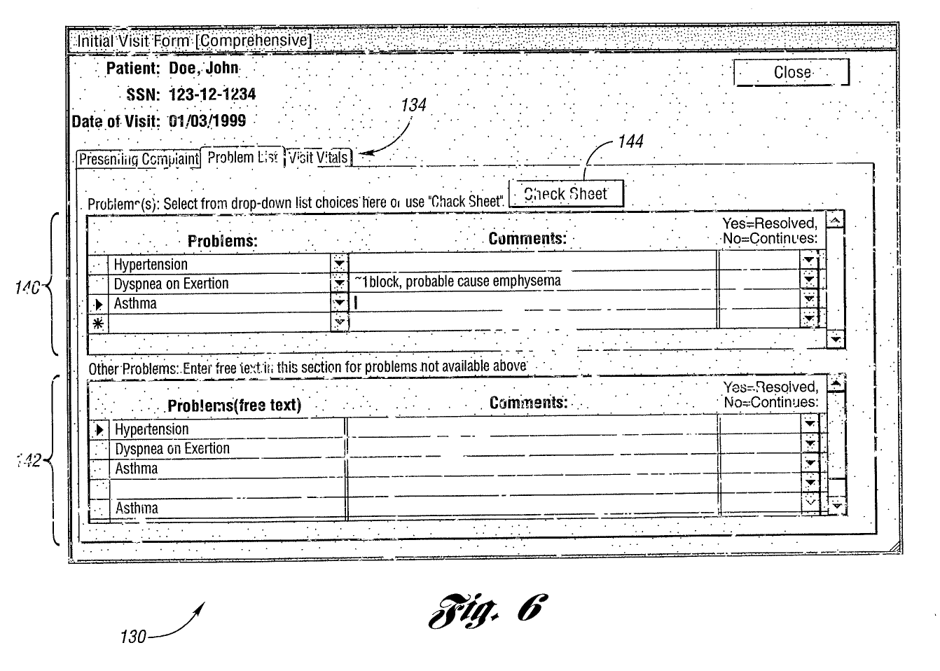

FIG. 6 illustrates an example GUI 130 for the “Visit Vitals/Complaint” patient encounter module. Initial visit form 130 comprises an indication of the patient's name, social security number, and date of visit as well as several data input form tabs 134 including “Presenting Complaint,” “Problem List” and “Visit Vitals.” The “Presenting Complaint” form (not shown) includes a user-defined indication of the referral type (e.g., Consultation Request) and a data input field allowing the user to input a textual description of the patient's general complaint. The “Problem List” form, as illustrated in FIG. 6, comprises a frame 140 for specifying the patient's medical problems using a drop-down menu approach based on a predefined database (discussed below) of patient medical problems. Alternately, the user can input the patient's medical problems in a free-text manner using lower frame 142. In each case, the user may enter free-text comments as well as an indication as to whether the patient's medical problems have been resolved. For patients having a variety of medical problems, the user selects a “Check Sheet” button 144 and is presented with pop-up window containing a selectable listing (not shown) of all medical problems included within the predefined database of patient medical problems.

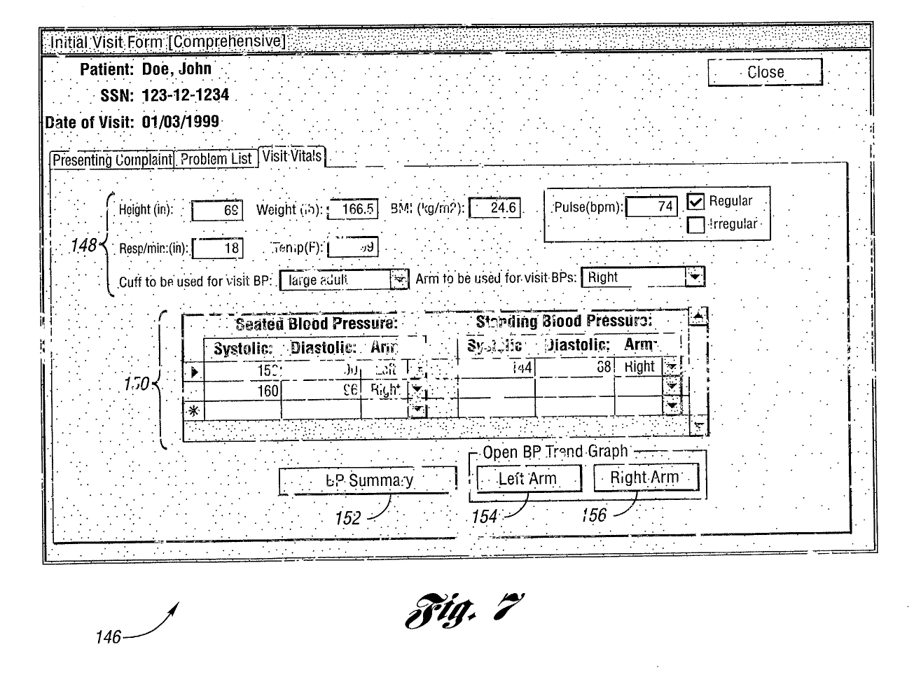

FIG. 7 is an example GUI 146 illustrating the “Visit Vitals” aspect of the “Visit Vitals/Complaint” patient encounter module. The visit vitals form 146 comprises data input fields 148 for specifying the patient's height, weight, BMI, Resp/min, temperature, pulse, cuff to be used for visit blood pressure assessments (BPs) and arm to be used for visit BPs. Additional data input fields 150 are provided for specifying the patient's systolic and diastolic seated and standing blood pressures by patient arm.

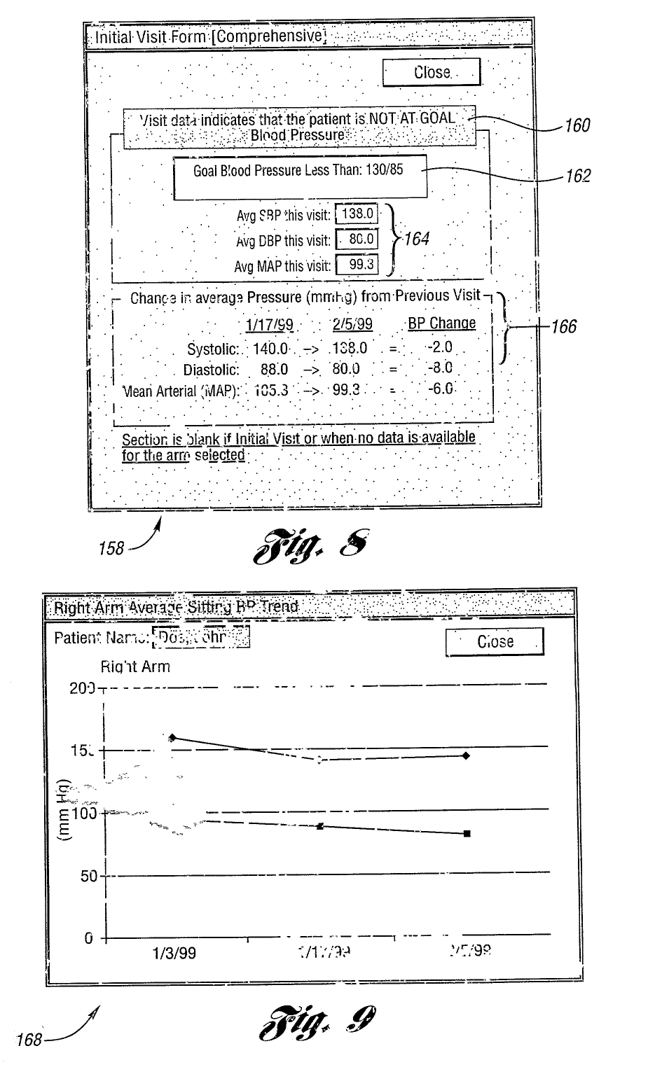

FIG. 8 is an example GUI 158 generated when a user selects the “BP Summary” button 152 shown in FIG. 7. One aspect of the patient blood pressure summary 158 includes an automatic indication 160 as to whether the patient is currently at or below his or her target blood pressure. Indication 160 is based upon a comparison between the patient's blood pressure information input into GUI 146 shown in FIG. 7 and a predefined blood pressure goal discussed below.

Another aspect of the patient blood pressure summary 158 includes an automatic indication 162 as to what the patient's goal blood pressure value is. Goal blood pressure indication 162 is based on criteria including but not limited to predefined logic based on a plurality of patient health parameters input into patient encounter modules. Additionally, goal blood pressure indication 162 may be based on patient risk factors such as patient history of heart failure, diabetes, or reduced kidney function. Table 1 contains a non-exclusive listing of logical statements and health risk factors that are applied to the patient's particular health parameters in determining the patient's goal blood pressure in accordance with the present invention.

TABLE 1

| Logical Criteria | Goal Blood Pressure (mmHg) |
|---|---|
| If urinary protein excretion > 1000 | <125/75 |
| mg/24 hours, then: | |
| If fasting glucose > 126 mg/dl or | <130/85 |
| taking diabetes medication, then: | |
| If random glucose > 200 mg/dl, then: | <130/85 |
| If EGFR < 60 ml/min/1.73 m², then: | <130/85 |
| If history of heart failure, then: | <130/85 |

Another aspect of the patient blood pressure summary 158 includes an indication 164 as to the patient's average systolic, diastolic and mean arterial blood pressures for the current visit. Average visit blood pressures are calculated on the averages of the arm measured and are based on the arm that has been selected for current and future measurements.

Yet another aspect of the patient blood pressure summary 158 includes an indication 166 of changes in the patient's average blood pressures since his or her previous visit.

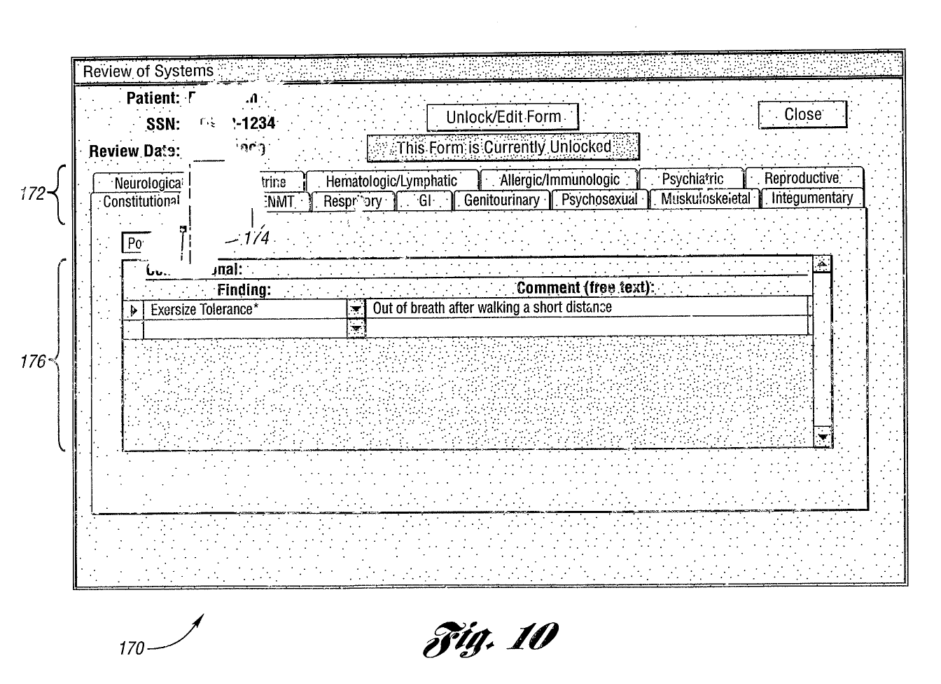

FIG. 9 is an example GUI 168 generated when a user selects the “Left Arm” or “Right Arm” blood pressure trend graph buttons 154 and 156 illustrated in FIG. 7. The blood pressure trend graph 168 illustrates a graphical profile of the patient's average blood pressure, by arm, by visit.

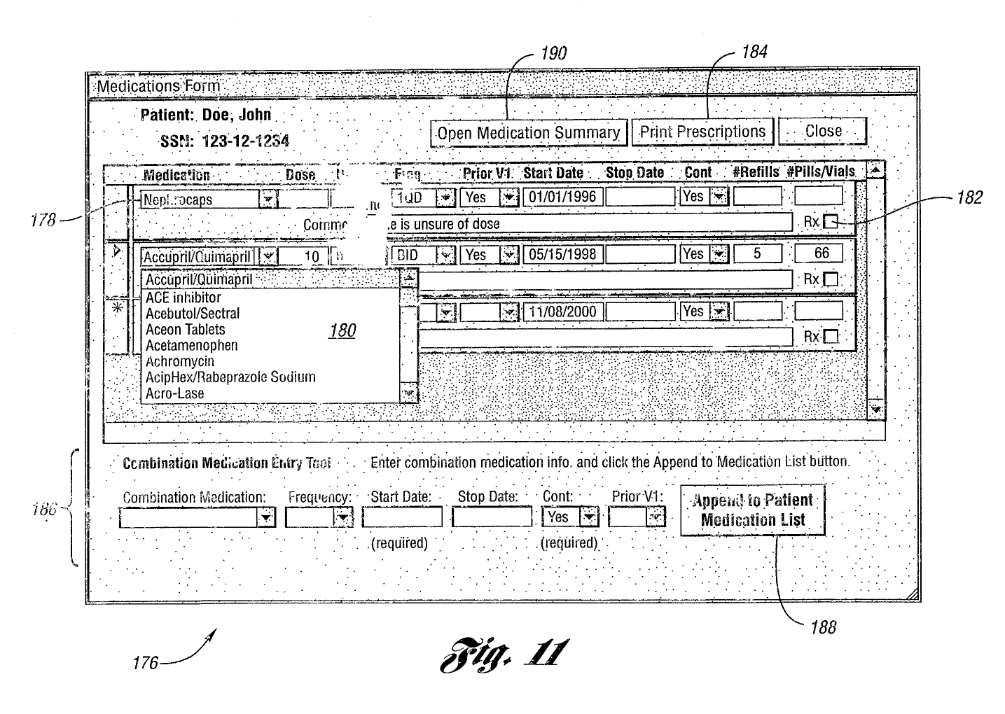

FIG. 10 illustrates an example GUI 170 for the “Review of Systems” patient encounter module. The “Review of Systems” GUI 170 comprises a plurality of form tabs 172 each having a plurality of data input and selection fields relevant to medically characterizing the current status of the patient's bodily systems. Bodily systems medically assessed via the “Review of Systems” patient encounter module include but are not limited to the patient's constitutional, vision, ear, nose, mouth and throat, respiratory, gastro-intestinal, psychosexual, musculoskeletal, integumentary, neurological, endocrine hematologic/lymphmatic, allergic/immunologic, psychiatric and reproductive systems. Notably, each system assessment form 172 includes corresponding finding and comment fields 175 and a system summary field 174 with which the user can summarize the overall condition of the patient's system as “Positive” or “Negative.”

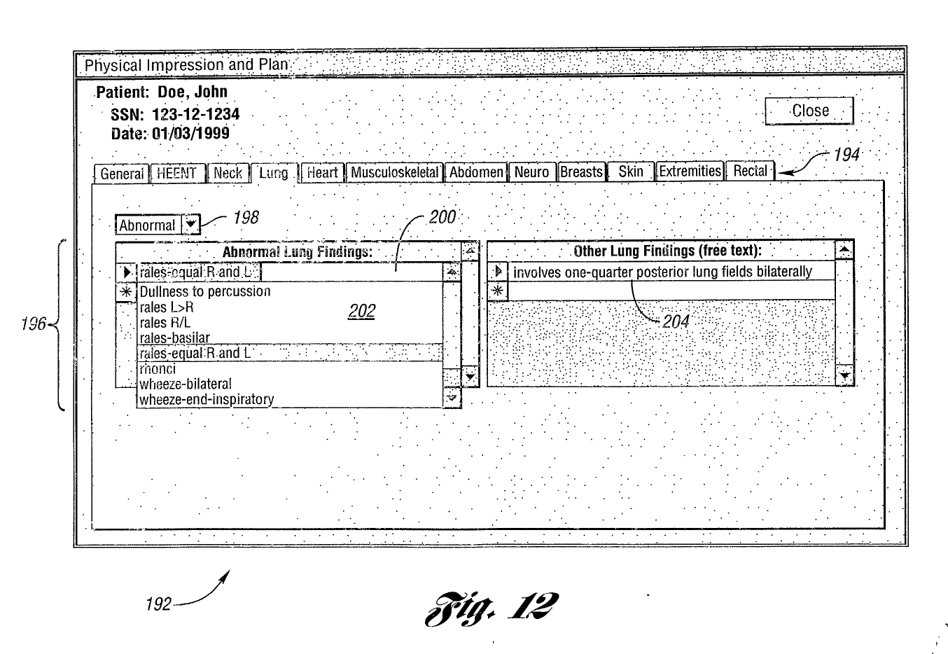

FIG. 11 illustrates an example GUI 176 for the “Medications” patient encounter module. The “Medications” GUI 176 comprises a plurality of data input and selection fields for defining a patient's current or newly-prescribed medications. Medication names 178 may be input manually or selected from a drop-down menu 180 containing a listing of predefined medications contained within a medication database discussed infra. For each medication, the user defines criteria including but not limited to: dosage, units, the frequency the medication is taken, whether the medication was prescribed prior to the patient's first visit with the current physician, the start date of the medication, the stop date (if applicable), whether the patient continues taking the medication after the current visit, the number of refills available for the prescription and the number of pills/vial.

Preferably, when a patient's medication or prescription is changed, a stop date is entered for the discontinued medication, and a new entry having a new start date is entered. Recording medications in this manner not only provides a history of the patient's medication changes, but tracks the number of medications the patient came into the clinic taking and how many the patient was taking at follow-up.

Radio buttons 182 are provided for each medication for specifying medications to print prescriptions for. To print a prescription for a particular medication, the user selects the corresponding “Rx” radio button 182 and selects the “Print Prescriptions” button 184.

A “Combination Medication Entry Tool” 186 is provided for appending combination medications to the patient's current medications. To append a combination medication, the user specifies the name, frequency, start date and stop date, indicates whether the patient is to continue taking the medication, indicates whether the combination medication was prescribed prior to the patient's first clinical visit and selects the “Append to Patient Medication List” button 188.

To open, view and/or print a report of the patient's medication history including the patient's current and combination medications, the user selects the “Open Medication Summary” button 190 and is presented with a separate pop-up window (not shown) containing the medication report.

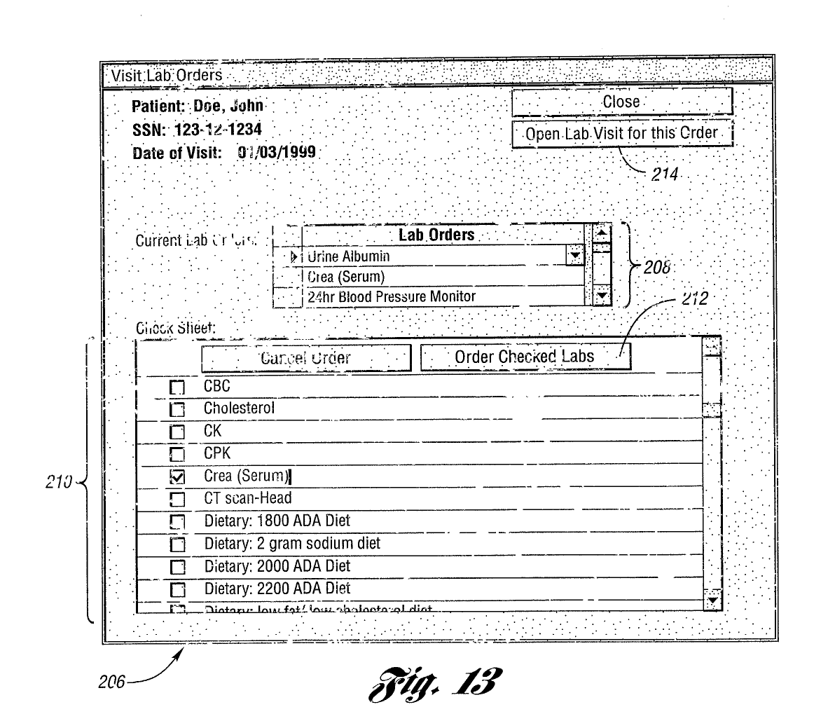

FIG. 12 illustrates an example GUI 192 for the “Physical Exam” patient encounter module. GUI 192 comprises a plurality of forms 194 each having a plurality of data input and selection fields 196 relevant to medically characterizing a particular body system. Each physical exam form 194 includes an indication 198 as to whether the patient's current condition with respect to that system is, overall, “Normal” or “Abnormal.” To define abnormal findings with respect to a particular bodily system, the user manually inputs the corresponding abnormalities into an abnormality listing 200 or selects the abnormalities from a drop-down menu 202 containing a listing of predefined abnormalities for that system contained within an abnormality database (discussed infra). A free-text input field 204 allows a user to input additional text-based comments corresponding to each abnormality.

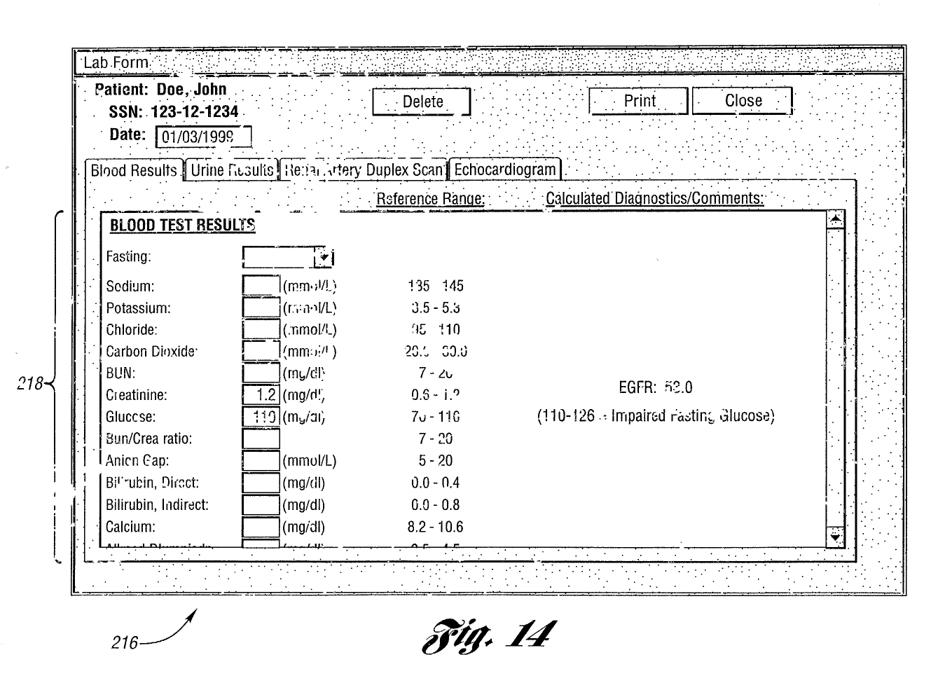

FIG. 13 illustrates an example GUI 206 for the “Visit Lab Orders” patient encounter module. This module allows a user to track laboratory orders and results associated with a patient's clinic visit. To specify labs to order, the user selects the lab from a drop-down list 208 or from a lab check-sheet 210. Next, the user selects the “Order Checked Labs” button 212. In response, the system prints the laboratory requisition with the appropriate laboratory tests requested. The patient takes the printed sheet to the lab where the test specimens are obtained and the laboratory measurements are performed.

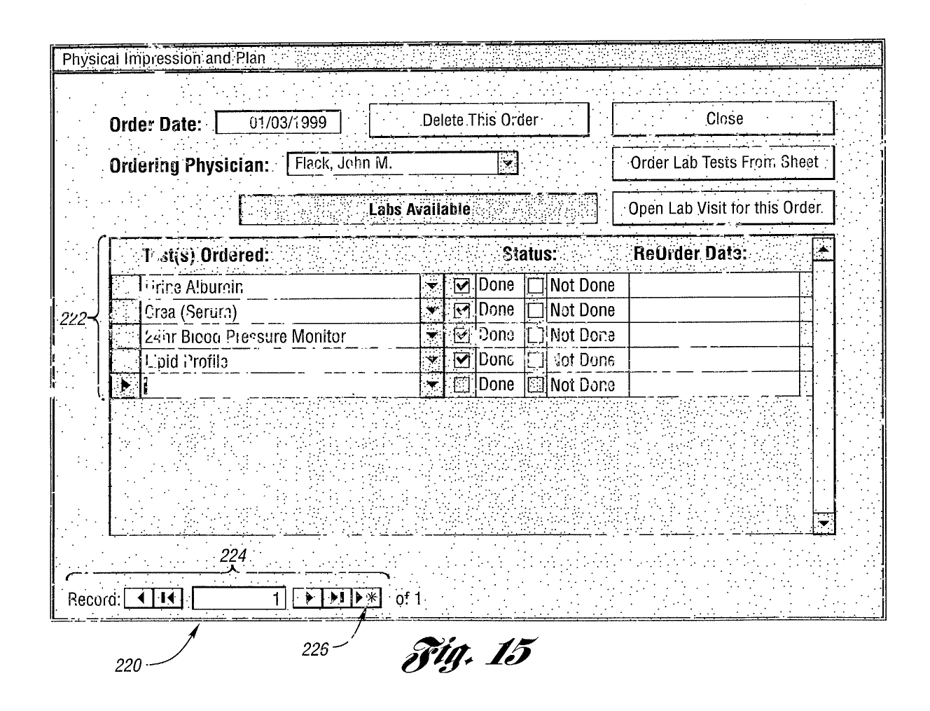

To enter the laboratory results associated with a lab order, the user selects the “Open Lab Visit for this Order” button 214 and is presented with the lab results entry form 216 illustrated in FIG. 14. Lab results entry form 216 comprises a plurality of data entry fields 218 corresponding uniquely to the ordered lab. Once the user receives the completed labs, the user inputs the lab results into the proper data entry field 218 (e.g., “Blood Test Results”). In some instances (not shown), lab reference ranges are listed and certain programmed diagnoses or comments may also display depending on the lab value entered.

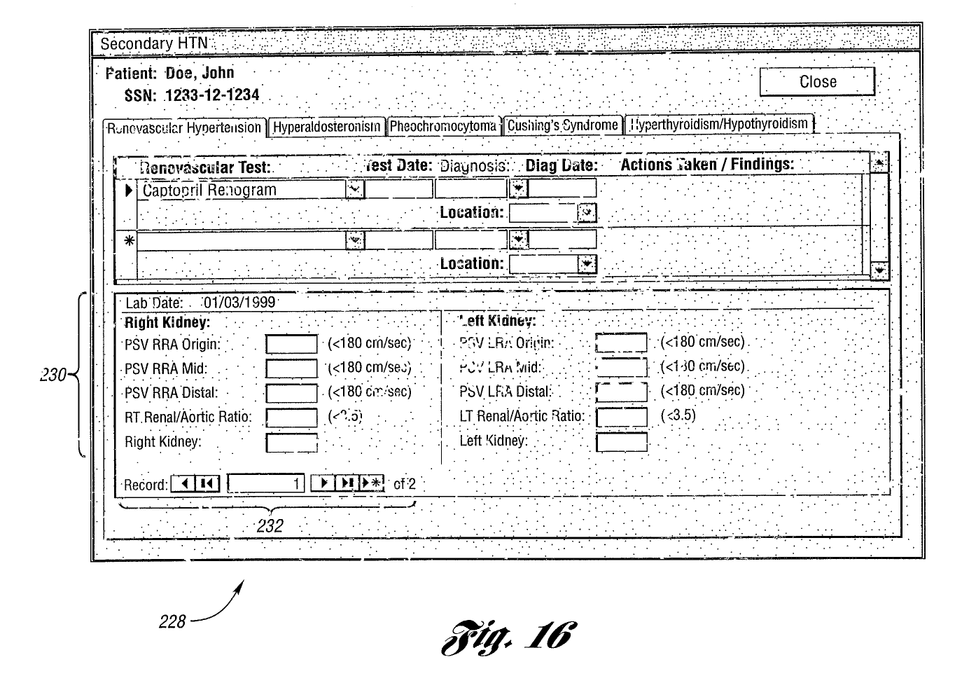

FIG. 15 illustrates an example GUI 220 for the “Index of Lab Orders” patient encounter module. This module allows a user to cross-reference lab tests that were performed with lab tests that were ordered. The module also allows the user to view lab orders for each patient visit which include an indication as to whether the lab results were entered. The lab order listing 222 appears in chronological order with the most recent record appearing first. Navigation buttons 224 are provided for toggling between lab orders. A new lab form button 226 is provided for creating a lab form associated with the patient's visit to a different or referring physician. Creating a new lab form in this manner allows a new lab order to be created without linking the lab order to the patient's current physician at the current clinic.

The “Preventative Health Form” patient encounter module (not shown) comprises a plurality of data fields for tracking the date of the patient's most recent vaccinations and other preventative health procedures the patient has received. Vaccinations tracked by the preventative health form include but are not limited to influenza, pneumococcal and tetanus. Preventative health procedures tracked include but are not limited to flexible sigmoidoscopy, colonoscopy, chest x-ray and mammogram. Other activities tracked include stool for occult blood, prostate specific antigen and homocysteine. For each preventative health activity listed, a data field is provided allowing the user to input additional text-based commentary.

The “Diabetes Care” patient encounter module (not shown) comprises a plurality of data fields for tracking information related to diabetic patients. One aspect of the diabetic information includes the patient's glucose monitoring for fasting, post-prandial and bedtime levels. Goal levels are provided as well as an indication as to whether the patient regularly meets his or her goal glucose levels. Another aspect of the diabetic information includes the patient's HgbAlc lab result history (i.e., date, level and commentary regarding whether the level indicated good glucose control or inadequate control). A third aspect of the diabetic information includes a plurality of data input fields for commenting on a plurality of patient conditions including but not limited to polyuia, nocturia, polydipsia, polyphagia, visual systems, hypoglycemia episodes, and numbness/parathesis of extremities.

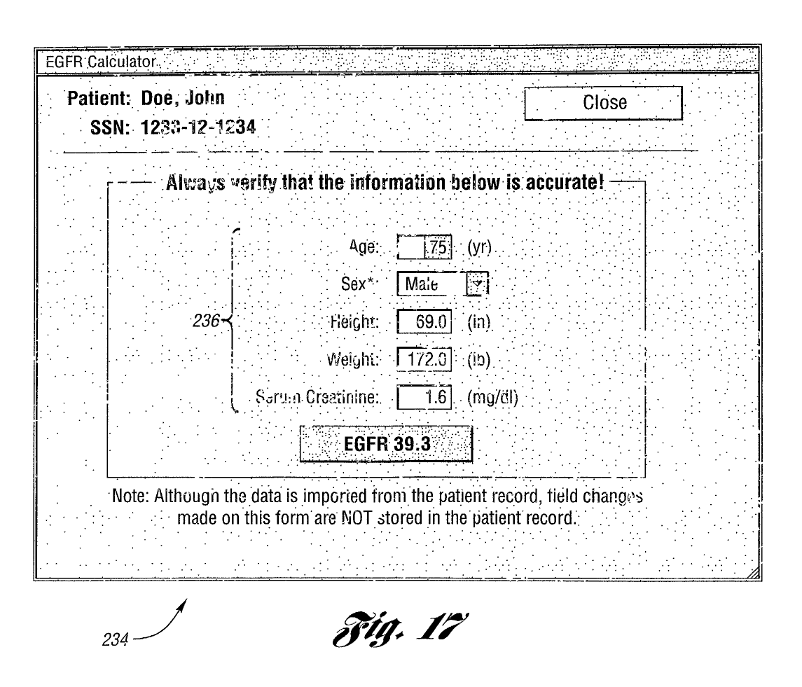

FIG. 16 illustrates an example GUI 228 for the “Secondary Hypertension” patient encounter module. Module 228 allows a user to track tests performed on a patient and patient lab values for a plurality of conditions related to secondary hypertension. The user can select tests to perform, test dates, diagnosis, and diagnosis dates, location, actions taken and findings. Subsets of lab results 230 are also provided. Navigation buttons 232 allow a user to toggle through the various lab results associated with each condition or create a new lab form.

In accord with a preferred embodiment of the present invention, the diagnosis of hypertension is based on the average clinic sitting blood pressure across the patient's clinic visits relative to the patient's goal blood pressure. Hypertension is diagnosed if a patient takes one blood pressure medication and BP≦130 mm Hg systolic and/or ≦85 mm Hg diastolic. Hypertension is also diagnosed where the patient takes more than one medication for blood pressure or if the average blood pressure in the selected are is greater than the goal blood pressure. If the patient takes one blood pressure medication, has BP<130 mm Hg systolic AND <85 mm Hg diastolic, and has no history of hypertension, the patient will be considered normotensive.

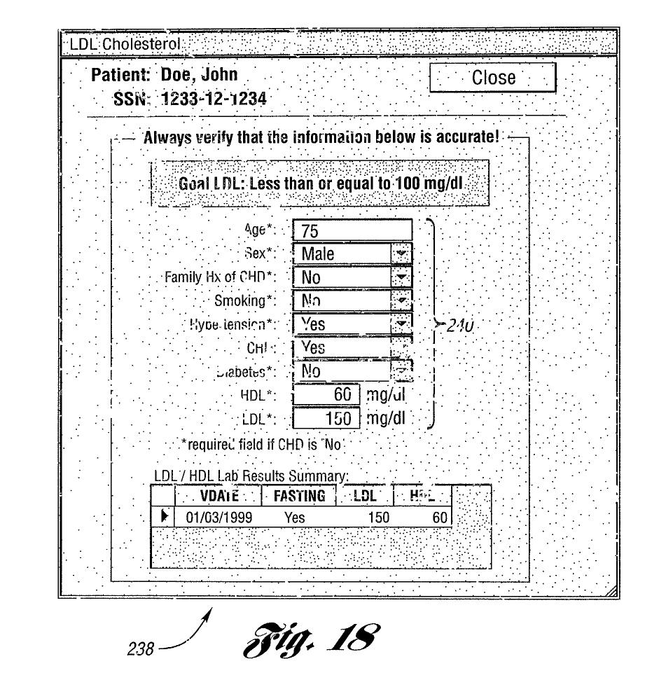

FIG. 17 illustrates an example GUI 234 containing an “Estimated Glomerular Filtration Rate” (EGFR) calculator in accordance with the preferred embodiment of the present invention. The EGFR calculator extracts patient information 236 previously entered which is necessary to calculate (i.e., estimate) the patient's glomerular filtration rate. In accord with a preferred embodiment, the patient's current data is automatically input into the appropriate data entry fields in an editable format. Default patient information can be edited for purposes of estimating the patient's glomerular filtration rate without changing the patient's information of record generated via the various patient encounter modules.

In accordance with a preferred embodiment of the present invention, the patient's glomerular filtration rate is estimated according to Equations 1 and 2:

$$EGFR = [ \frac{( ( 140 - AGE ) \times WEIGHT ( kg ) )}{72 \times SCR} ] \times [ \frac{1.73}{BSA} ] \qquad Eqn . 1$$

BSA=0.007184×[HEIGHT(cm)^{0 725}]×[WEIGHT(kg)^{0 425}] Eqn. 2

For female patients, the EGFR is multiplied by 0.85 to correct for gender differences in muscle mass and average rate of creatinine synthesis.

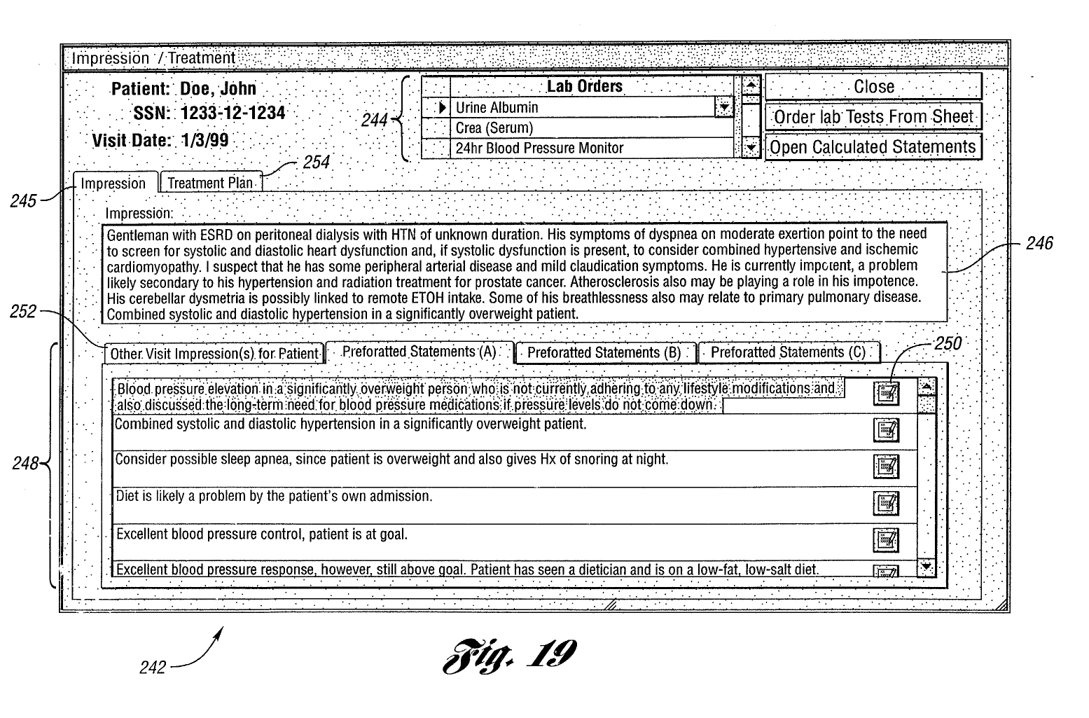

FIG. 18 illustrates an example GUI 238 containing an “LDL Cholesterol Goal” calculator in accordance with the present invention. The cholesterol goal calculator extracts patient information 240 previously entered which is necessary to calculate (i.e., estimate) the patient's goal LDL cholesterol level. The patient's current data is automatically input into the appropriate data entry fields in an editable format. Default patient information can be edited for purposes of estimating the patient's goal LDL cholesterol level without changing the patient's information of record generated via the various patient encounter modules.

In accordance with a preferred embodiment of the present invention, the combined consideration of whether the patient has CHD or diabetes and the member of coronary heart disease risk factors.

Notably, a variety of patient treatment goals may calculated and/or automatically generated based on patient records in accord with the present invention. Other patient treatment goals envisioned include, but are not limited to, target blood pressure (as illustrated and described in FIG. 8), target lipid levels and target hemoglobin A1C levels.

The “Cranial Nerve Exam,” “Bioz Form (Plethysmography)” and “Sleep Apnea Questionnaire” patient encounter modules (not shown) each comprise a separate GUI for assessing the patient's corresponding conditions. The cranial nerve exam GUI comprises a plurality of data input fields for assessing the condition of the patient's olfactory, optic and occulomotor skills. The bioz form GUI comprises a plurality of data input fields for assessing the condition of the patient's heart rate, mean arterial pressure, cardiac index, cardiac output, stroke index, stroke volume, systematic vascular resistance index, systematic vascular resistance, acceleration index, velocity index, thoracic fluid content, left cardiac work index, systolic time ratio, pre-ejection period, and left ventricular ejection time. The sleep apnea questionnaire GUI comprises a plurality of questions for generally assessing the patient's likelihood of suffering from sleep apnea.

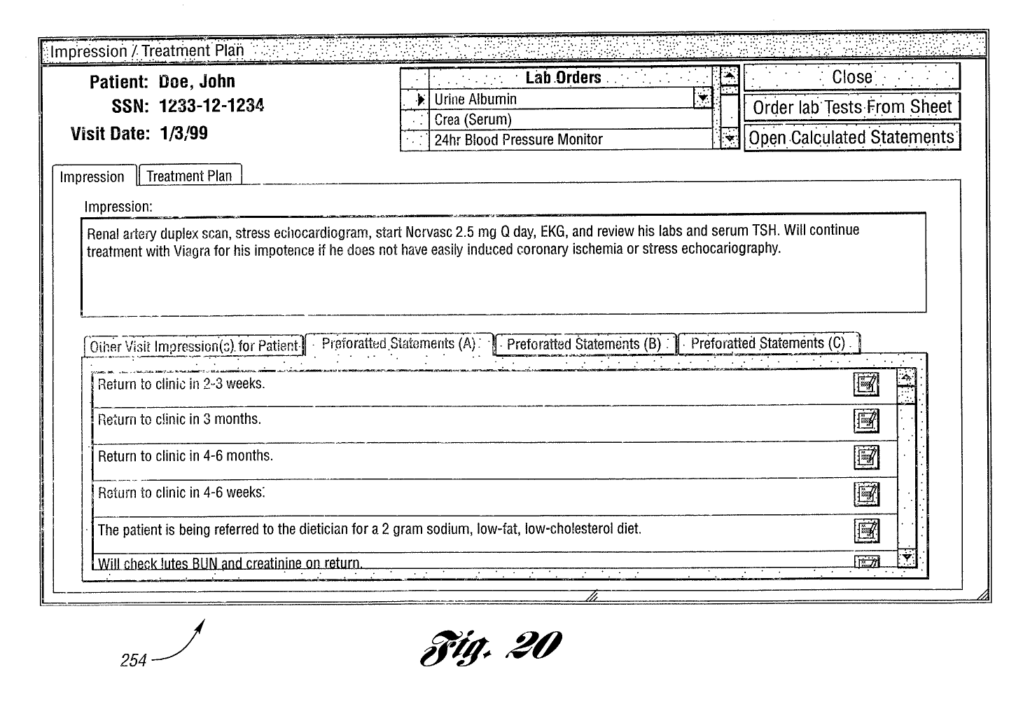

FIG. 19 illustrates an example GUI 242 for the “Impression/Treatment Plan” patient encounter module. One aspect of the “Impression/Treatment Plan” patient encounter module comprises a lab order request form 244. Lab orders may be requested either via the “Impression/Treatment Plan” patient encounter module illustrated in FIG. 19 or the “Visit Lab Orders” patient encounter module illustrated previously in FIG. 13.

Another aspect of the “Impression/Treatment Plan” patient encounter module comprises a form 245 for defining the physician's medical impression of the patient. The user (i.e., physician) may input his or her medical impression of the patient manually via text field 246. Alternately, the user may select from a plurality of “Preformatted Statements” 248. To add a preformatted statement to a current medical impression, the user selects the append button 250 corresponding to the desired preformatted statement. Additionally, a form 252 is provided for presenting and appending selections from a historical listing of patient impressions input during previous clinic visits.

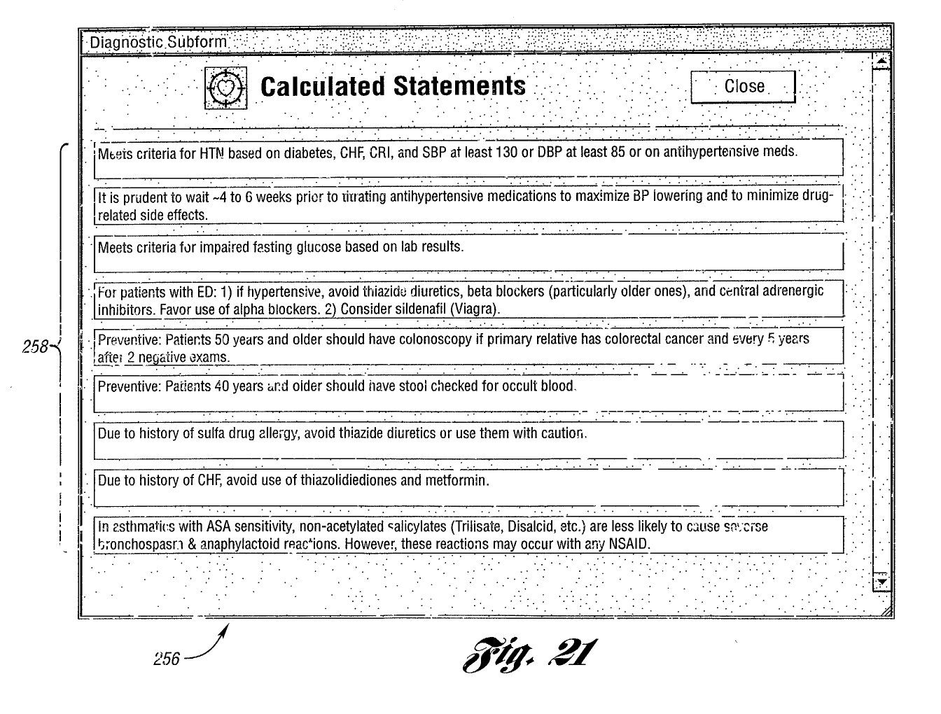

Yet another aspect of the “Impression/Treatment Plan” patient encounter module comprises a form 254 (also illustrated in FIG. 20) for defining a medical treatment plan for the patient. Generally the layout and operation of the treatment plan is similar in appearance and function to the medical impression form 245 discussed above.

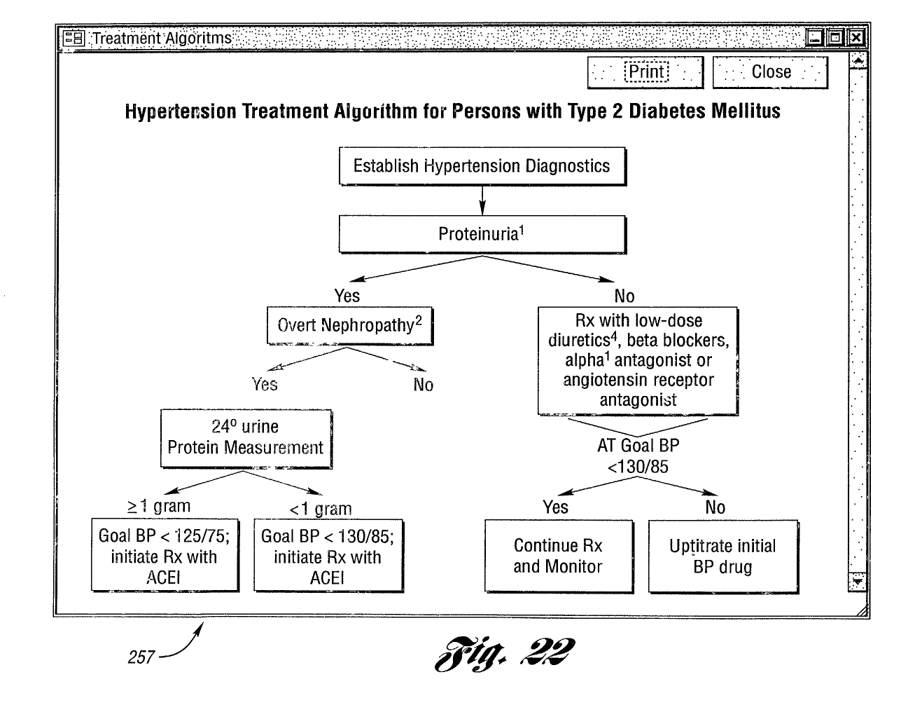

FIG. 21 illustrates an example GUI 256 for the “Calculated Statements” patient encounter module. Calculated statements include comments and suggestions 258 that are automatically generated by the present invention for assisting the user (i.e., physician) in defining the patient's treatment plan. In accord with one embodiment of the present invention, the calculated statements listed within GUI 256 are determined based on a comparison between the current patient data input or specified via the preceding patient encounter modules, where applicable, and a plurality of predefined medical treatment logic. Table 2 contains a listing of logic pertaining to various patient health criteria and corresponding calculated statements that are generated in the event the logic is “True.” The logical treatment statements and corresponding treatment recommendations included within Table 2 are for illustrative purposes are do not reflect an exhaustive collection of all possible logical statements and treatments that may be implemented in accord with the present invention.

TABLE 2

| Patient Health Parameter Logic | Calculated Treatment Statement |
|---|---|
| When EGFR < 48 ml/min/1.73 m²: | Thiazide diuretics are likely to be |
| | ineffective; loop diuretics or |
| | zaroxylyn should be utilized. |
| When EGFR < 55 ml/min/1.73 m² | Glucophage should be avoided if |
| and glucophage is prescribed: | possible. |
| When a patient has hypertension | Avoid NSAIDs except for clinoril/ |
| and the physician adds an NSAID: | sulindac, though tylenol and ASA are |
| | OK as NSAIDS may take blood |
| | pressure. |
| When the patient has hypertension | Consider stopping NSAIDs unless on |
| and has already been prescribed an | clinoril/sulindac, though tylenol and |
| NSAID: | ASA are OK as NSAIDS may raise |
| | blood pressure. |
| When a male patient has hyperten- | Consider adding a thiazide diuretic. |
| sion and takes > 2 antihypertensive | |
| medications and BP > goal BP and | |
| estimated GFR is > 48 ml/min/ | |
| 1.73 m². | |
| When a patient has hypertension | Consider adding a loop diuretic or |
| and takes > 2 antihypertensive | metolazone; thiazides are likely |
| medications and BP > goal BP and | ineffective. |
| estimated GFR is < 48 ml/min/ | |
| 1.73 m². | |
| If there is a history of angioedema: | Avoid ACE inhibitors and |
| | angiotensin receptor blockers. |
| If there is a history of bilateral | Avoid ACE inhibitors and |
| renal artery stenosis: | angiotensin receptor blockers. |
| If there is a history of sulfa drug | Avoid thiazide and loop diuretics or |
| allergy: | use them with caution. |
| If there is a history of congestive | Due to history of CHF, avoid use of |
| heart failure: | thiazolidiediones and metformin. |
| If serum potassium ≧ 5: | Due to high serum potassium, favor |
| | angiotensin receptor blockers over |
| | ACE inhibitors and consider discon- |
| | tinuation of NSAIDs except clinoril/ |
| | sulindac, potassium supplements, |
| | potassium-sparing diuretics, & |
| | heparin. |
| If serum potassium < 3.5 meq/l | Advise and send patient for “low” |
| and taking any diuretic then: | [<2 grams] sodium diet, lower |
| | diuretic dose, consider the addition of |
| | a potassium sparing diuretic or ACE |
| | inhibitor. |
| If serum potassium < 3.5 meq/l | Patient should be screened for |
| and not taking any diuretic then: | primary hyperaldosteronism, or if |
| | ingesting large quantities of red |
| | licorice, should reduce their intake of |
| | the same, also consider screening for |
| | hypomagnesemia. |
| When the patient has hypertension | Consider screen for renovascular |
| and serum creatinine > 1.4 mg/dl | hypertension. |
| or estimated GFR < 60 ml/min/ | |
| 1.73 m²: | |
| Patient is prescribed antihyperten- | It is prudent to wait ˜4 to 6 weeks |
| sive medication or antihypertensive | prior to titrating antihypertensive |
| medication is changed: | medications to maximize BP lower- |
| | ing and to minimize drug related side |
| | effects. |
| If patient has erectile dysfunction | For patients with ED: 1) if hyperten- |
| based on review of systems: | sive, avoid thiazide diuretics, beta |
| | blockers (particularly older ones), |
| | and central adrenergic inhibitors. |
| | Favor use of alpha blockers, 2) |
| | consider sildenafil (Viagra). |
| If patient is prescribed sildenafil | Patients taking sildenafil who have a |
| and has a history of liver disease, | history of liver disease, chronic renal |
| chronic renal insufficiency or > 65 | insufficiency or > 65 years old should |
| years old: | use the minimum dose. |
| If patient prescribed sildenafil and | Use sildenafil with caution in patients |
| has 1) conditions predisposing | with 1) conditions predisposing them |
| them to priaprism or 2) anatomic | to priaprism, i.e., sickle cell disease, |
| deformity of the penis: | myeloma, leukemia or 2) anatomic |
| | deformity of the penis. |
| If erythromycin, ketoconazole, | Avoid prescribing sildenafil and |
| itraconazole, ritonavir, saquinavir, | medications in this class |
| or any other drug in the protease | concurrently. |
| inhibitor class (all cytochrome | |
| P450 CYP 3A4 inhibitors], or any | |
| form of nitrates or nitroprusside is | |
| concurrently prescribed with | |
| sildenafil: | |
| If patient is taking cimetidine and | Levels of sildenafil can be raised by |
| is prescribed sildenafil: | this compound. If you haven't |
| | already, consider the 25 rather than |
| | 50 or 100 mg dose of sildenafil. |
| If patient is taking nitrates and is | Avoid prescribing sildenafil and |
| prescribed sildenafil: | nitrates (or nitroprusside) |
| | concurrently. |
| If the patient is taking a Macrolide | Avoid prescribing sildenafil and this |
| antibiotic: | antibiotic concurrently. |
| Flu shot ordered: | Flu shot is contraindicated for those |
| | with allergy to eggs. |
| If estimated glomerular filtration | The most appropriate diuretics are |
| rate (EGFR) ≦ 48 ml/min/1.73 m²: | metolazone or furosemide (dose twice |
| | daily); thiazides including |
| | chlorthalidone are likely to be |
| | ineffective. |
| In diabetics: | HgbA1c should be monitored at least |
| | twice yearly in persons meeting |
| | goals, or quarterly if patient is not |
| | meeting goals OR medications have |
| | changed. |
| | Annual dilated eye & visual examina- |
| | tion by an optometrist or |
| | ophthalmologist in patients > 10 yrs |
| | having had diabetes for 3-5 years |
| | AND all patients diagnosed after 30 |
| | years and patients with visual |
| | symptoms/abnormalities. |
| Patients who are pregnant and | Patients who are pregnant and taking |
| taking ACE inhibitors or | ACE inhibitors or angiotensin |
| angiotensin receptor antagonists | receptor antagonists should STOP. |
| If attempting pregnancy: | If attempting pregnancy, AVOID |
| | ACE inhibitors and angiotensin |
| | receptor antagonists. |
| In asthmatics with ASA sensitivity: | Non-acetylated salicylates (Trilisate, |
| | Disalcid, etc.) are less likely to cause |
| | severe bronchospasm & |
| | anaphylactoid reactions. However, |
| | these reactions may occur with any |
| | NSAID. |
| In cases where cardiac ejection | Consider spironolactone therapy @ |
| fraction < 35% and serum | 25 mg/day. |
| creatinine < 2.5 mg/dl and serum | |
| K+ < 5.5 mg/dl: | |
| When serum K+ < 3.5 mg/dl and | Consider adding a K+ sparing |
| on a diuretic: | diuretic. If not already prescribed, |
| | also consider ACE inhibitor, |
| | angiotensin receptor antagonist, and/ |
| | or intensifying dietary sodium |
| | restrictions. |
| When serum K+ < 3.5 mg/dl and | Consider decreasing dose of diuretic |
| on a potassium sparing diuretic: | and/or intensifying dietary sodium |
| | restrictions. |
| Patient is 50 years of age or older: | Patients 50 years and older should |
| | have colonoscopy if primary relative |
| | has colorectal cancer and every five |
| | years after 2 negative exams. |
| Patient is 40 years of age or older: | Patients 40 years and older should |
| | have stool checked for occult blood. |
| Patient is female and over 34: | Mammogram; baseline = 35 to 39 |
| | years old; every 1 to 2 years = 40 to |
| | 49 years old; yearly = 50 and over. |
| Patient is female and over 17: | Pap smears to begin at 18 years; |
| | every 2 years after 3 negative Paps; |
| | every one to two years for women 40 |
| | years and older. |

Another aspect of the present invention configured to assist a user/physician in properly defining a patient's treatment plan includes a plurality of diagnostic work-up algorithms (i.e., annotated logical flow charts, etc.). Diagnostic work-up algorithms assist a practitioner to form a diagnosis for a patient when the practitioner suspects (or when the software automatically suggests) a particular medical condition such as renovascular hypertension or mineralocorticoid hypertension.

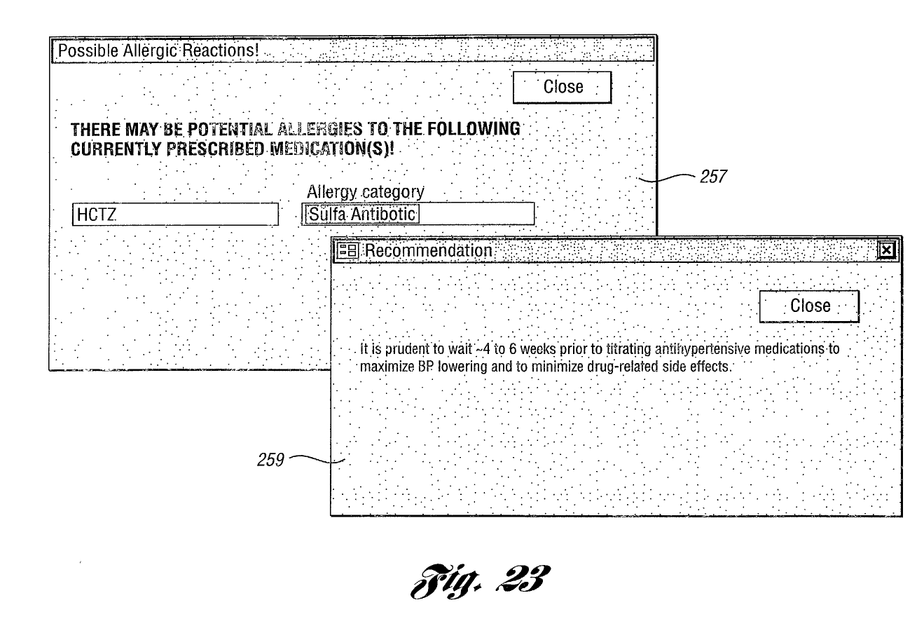

FIG. 22 illustrates an example portion of a graphical treatment algorithm 257 pertaining particularly to “Hypertension Treatment for Persons with Type 2 Diabetes Mellitus.” Other graphical diagnostic and treatment algorithms presented in accord with the present invention include but are not limited to treatment of cholesterol in persons with diabetes mellitus, evaluation of suspected renovascular hypertension, and evaluation of suspected hyperaldo stetonism.

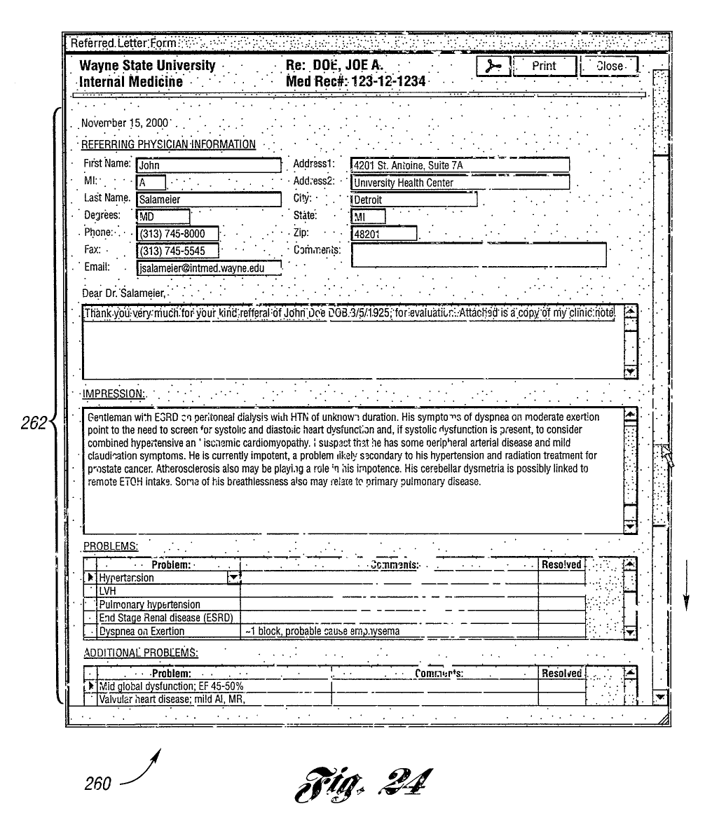

Yet another aspect of the present invention configured to assist a user/physician in properly defining a patient's treatment plan, and prescribing treatment generally, includes a variety of pop-up warning alerts and treatment recommendations. In accord with a preferred embodiment of the present invention, pop-up warnings and recommendations are automatically generated based on medically sensitive patient health/treatment parameters including but not limited to those listed in Table 2 as well as other conditions such as the prescription of a medication the patient may be allergic to. FIG. 23 illustrates example pop-up windows 257 and 259 that are automatically generated based on the status of the patient's medical record and/or user activity. In accord with the example, a warning similar to that contained in pop-up 257 is automatically generated upon prescribing a medication for the patient that, based on the patient's medical record, the patient is allergic to. A recommendation similar to that contained in pop-up 259 is automatically generated by the software in response to a user prescribing an antihypertensive medication or when an antihypertensive medication is changed.

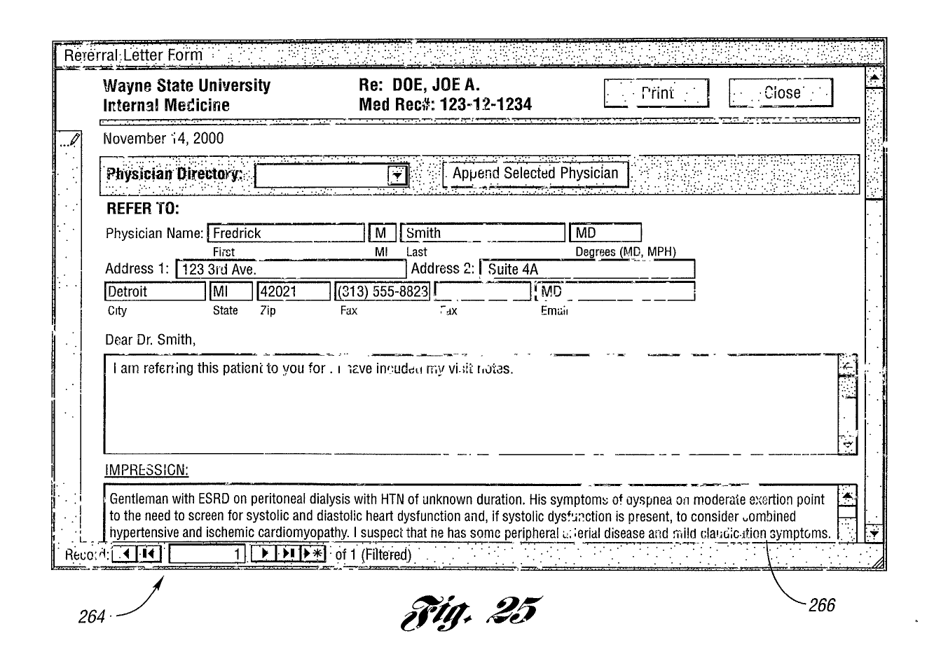

FIG. 24 illustrates an example GUI 260 for the “Thank You for Referral Letter” patient encounter module. This module allows the user to summarize the patient's visit in a printable format for a referring physician (if any). Notably, the fields 262 included within GUI 260 correlate directly (and may receive content indirectly from) the applicable patient encounter modules discussed above. Any changes to either the fields 262 or their respective patient encounter modules automatically update the patient's data of record. Fields 262 within the “Thank You for Referral Letter” include but are not limited to referring physician information, a brief personal statement to the physician (entered via GUI 260), the current physician's impression of the patient, the patient's current medical problems including associated comments and the physician's recommended treatment plan followed by a brief personal closing statement.

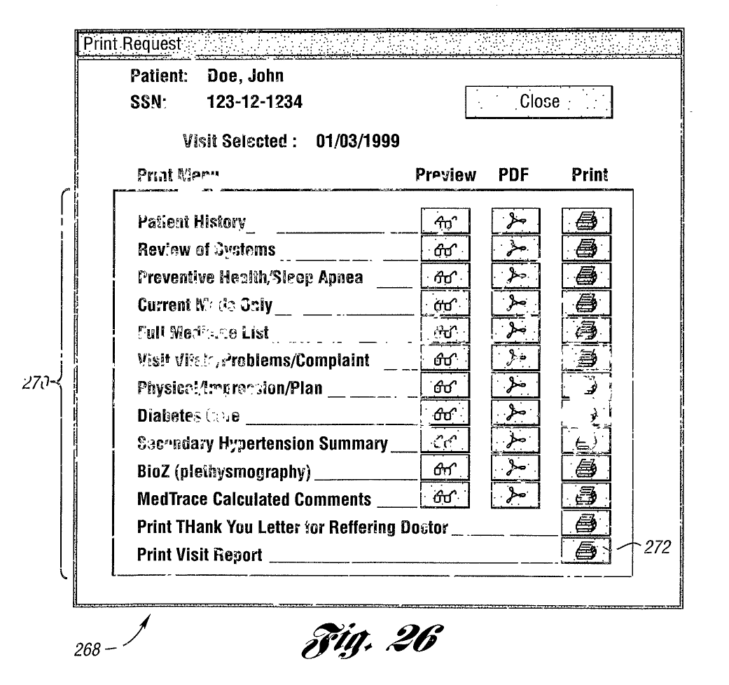

FIG. 25 illustrates an example GUI 264 for the “Refer to Physician Letter” patient encounter module. This module allows the user to summarize the patient's visit in a printable format for assisting a physician to whom the patient is referred (if any). Similar to the “Thank You for Referral Letter” patient encounter module illustrated in FIG. 24, certain fields 266 included within GUI 264 correlate directly (and may receive content indirectly from) the applicable patient encounter modules discussed above. Any changes to either the fields 266 or their respective patient encounter modules automatically update the patient's data of record. Fields within the “Refer to Physician Letter” include but are not limited to the “refer to” physician information, a brief personal statement to the physician (entered via GUI 264), the current physician's impression of the patient, the patient's current medical problems including associated comments and the physician's recommended treatment plan followed by a brief personal closing statement.

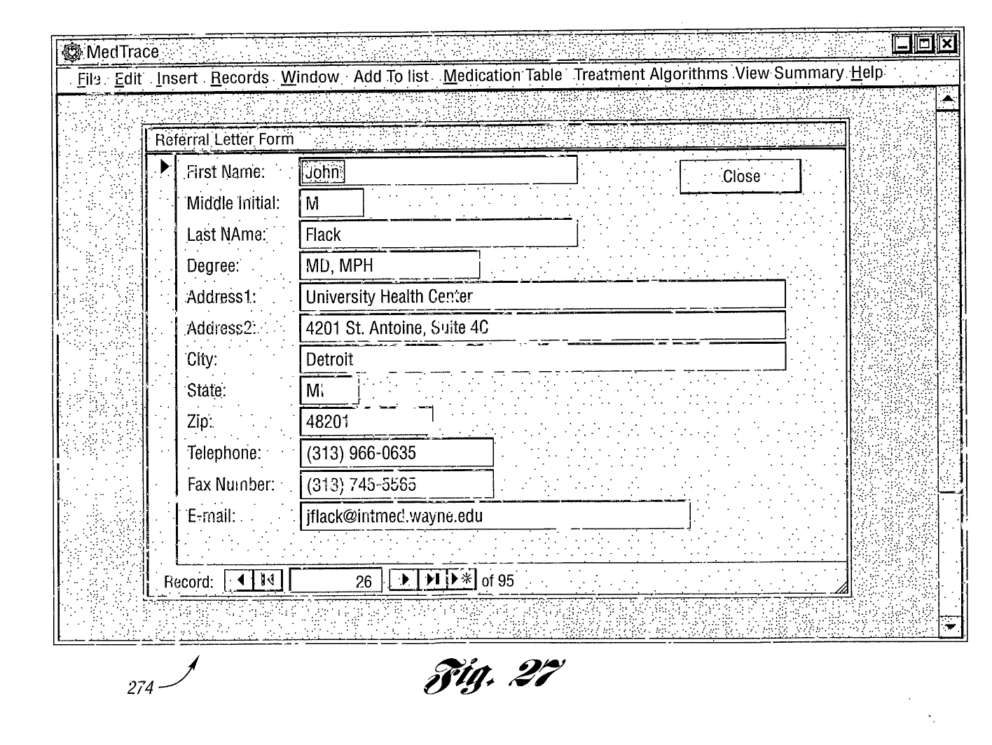

FIG. 26 illustrates an example GUI 268 for the “Print Visit” patient encounter module. This module allows a user to preview, generate a portable document file (PDF), or print patient visit summaries corresponding to the various patient encounter modules 270 discussed above. To print all reports associated with a particular patient visit, the user selects the “Print Visit Reports” icon 272.

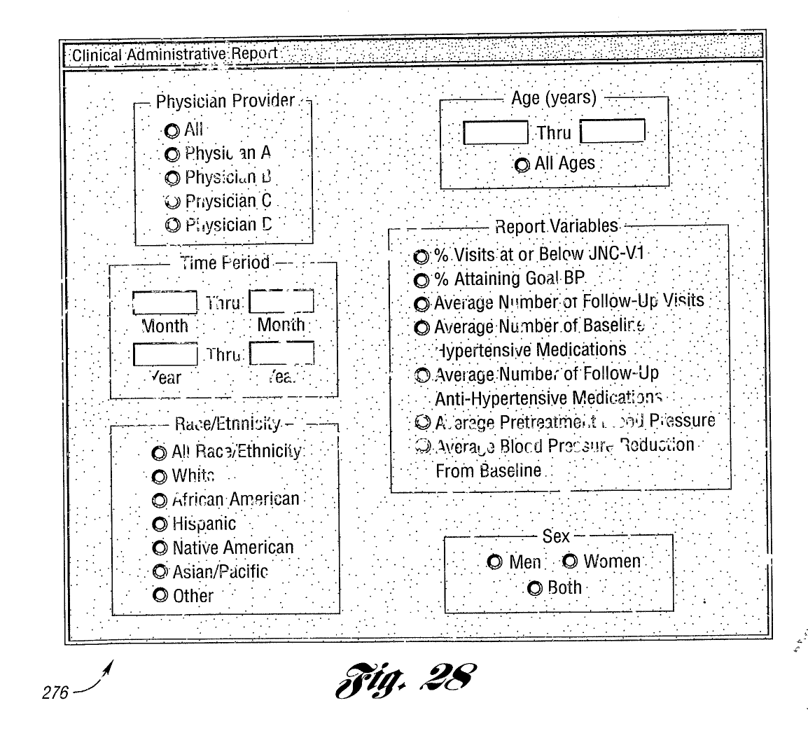

As discussed in various instances supra, various drop-down menus included within the various patient encounter modules contain predefined (i.e., user-defined) data selections (e.g., physicians, problems, medications, lab tests, physical, review of systems, etc.). In accord with a preferred embodiment of the present invention, a database is maintained for each predefined listing. FIG. 27 illustrates an example GUI 274 for browsing, updating and adding physicians to the physician database. Problems, medications, lab tests, physical examinations and review of systems examinations are added in a similar fashion, each database having it unique attributes as applicable (i.e., medications defined in terms of name, dosage, units, frequency, etc.).

### Aggregate Clinical Reports

Another aspect of the present invention comprises functionality for generating a variety of clinical reports which are automatically populated with an aggregation of relevant patient healthcare metrics. In accord with a preferred embodiment of the present invention, patient healthcare metrics for populating aggregate clinical reports are globally or semi-globally extracted from patient medical records created and updated as described in detail supra.

FIG. 28 illustrates an example GUI 276 for generating a aggregate clinical report. Aggregate clinical reports generated in accordance with the present invention set forth comparative data such as, for example, for a particular healthcare provider, the level of congruence between actual blood pressure levels 278 for treated patients and goal blood pressure levels 280 such as those recommended by the JNC-VI.

Automatic data extraction from patient records may be customized to execute in a global or semi-global fashion. Data extraction in a global fashion automatically extracts relevant patient criteria from all medical records generated in accord with the present invention. Data extraction in a semi-global fashion extracts (or excludes from extraction) user-defined or default patient criteria and/or records. For example, data populating the aggregate clinical report illustrated in FIG. 28 may be limited by a user or by default to patient records generated or patient encounters occurring in year 2000. In another example, patient records pertaining only to female patients populate the aggregate clinical report. A wide variety of aggregate report and data query formats are envisioned within the scope of the invention.

Notably, aggregate clinical reports generated in accord with the present invention are not limited to the example content comparisons and ranges illustrated in FIG. 28. Other reports may demonstrate, for example, the proportion of patients with diabetes who had urine protection quantitation or measurement of hemoglobin A1C levels, the proportion of eligible persons receiving influenza or pneumococcal vaccination and the proportion of persons who have attained goal lipid and cholesterol levels.

In a general sense, aggregate clinical reports provide healthcare providers with information about their healthcare practice that can be used to assess, for example, the quality of healthcare treatment, healthcare processes undertaken and the clinical outcomes of patient treatment.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A patient healthcare management system having a capability to evaluate patient kidney function, the system configured to:
receive input defining a patient's medical record including the patient's demographic information, medical condition and diagnosis;
calculate the patient's estimated glomerular filtration rate based on the patient's medical record;
output at least one medical treatment recommendation wherein the recommendation is based on the patient's medical record and estimated glomerular filtration rate; and
calculate and output at least one treatment goal for the patient.

2. The system of claim 1 wherein the at least one treatment goal for the patient comprises at least one of:
a goal blood pressure, a goal lipid level, a goal cholesterol level and a goal hemoglobin A1C level.

3. The system of claim 1 additionally configured to receive input specifying a treatment for the patient.

4. The system of claim 1 additionally configured to output an indication as to whether, based on the patient's medical record, the at least one medical treatment goal has been met.

5. The system of claim 1 wherein a plurality of clinical treatment algorithms are applied to the patient's medical record to generate the at least one treatment recommendation and the at least one patient treatment goal.

6. The system of claim 1 additionally configured to:
receive input specifying a patient's current medication(s);
receive input specifying a new prescription for the patient; and
generate an alert if the prescribed medication may antagonize a medication the patient is currently taking.

7. The system of claim 1 further configured to:
receive input defining a plurality of patient medical records comprising patient demographic information, medical condition, diagnosis and treatment;
receive input defining at least one medical record parameter to extract from the plurality of medical records; and
automatically generate a report containing an aggregate of the at least one medical record parameter extracted from the plurality of medical records.

8. The system of claim 7 further configured to receive input defining a subset of the plurality of patient medical records from which to extract the at least one medical record parameter.

9. The system of claim 1 additionally configured to receive input, for each patient encounter with his or her healthcare provider, defining the patient encounter wherein each defined patient encounter is appended to the patient's medical record.

10. A computer-implemented patient healthcare management method involving the evaluation of patient kidney function, the method comprising:
defining a patient's medical record including the patient's demographic information, medical condition and diagnosis;
calculating the patient's estimated glomerular filtration rate based on the patient's medical record;
automatically generating at least one medical treatment recommendation based on the patient's medical record and estimated glomerular filtration rate; and
calculating at least one treatment goal for the patient.

11. The method of claim 10 wherein the at least one treatment goal for the patient comprises at least one of a goal blood pressure level, a goal lipid level, a goal cholesterol level and a goal hemoglobin A1C level.

12. The method of claim 10 further comprising specifying a treatment for the patient.

13. The method of claim 10 further comprising indicating whether, based on the patient's medical record, the at least one patient treatment goal has been met.

14. The method of claim 10 wherein a plurality of clinical treatment algorithms are applied to the patient's medical record to generate the at least one treatment recommendation and the at least one patient treatment goal.

15. The method of claim 10 further comprising:
specifying the patient's current medications;
specifying a new prescription for the patient; and
generating an alert if the prescribed medication may antagonize a medication the patient is currently taking.

16. The method of claim 10 further comprising:
defining a plurality of patient medical records comprising patient demographic information, medical condition, diagnosis and treatment;
defining at least one medical record parameter to extract from the plurality of medical records; and
automatically generating a report containing an aggregate of the at least one medical record parameter extracted from the plurality of medical records.

17. The method of claim 16 further comprising defining a subset of the plurality of patient medical records from which to extract the at least one medical record parameter.

18. The method of claim 10 further comprising defining each patient encounter with his or her healthcare provider wherein the defined patient encounter is appended to the patient's medical record.

19. A computer-based system for interactively managing patient healthcare and evaluating patient kidney function, the system comprising:
a means for defining a patient's medical record;
a means for establishing the patient's estimated glomerular filtration rate based on the patient's medical record;
a means for generating at least one patient treatment recommendation based on the patient's medical record and estimated glomerular filtration rate; and
a means for calculating at least one treatment goal for the patient.
